(19) United States
(12) Patent Application Publication
(10) Pub. No.: US 2013/0346333 A1
(43) Pub. Date: Dec. 26, 2013

(54) SYSTEM AND METHOD FOR RECEIVING REQUESTS AND RESPONDING TO EMERGENCIES

(71) Applicant: Parlant Technology, Inc., Provo, UT (US)

(72) Inventors: Bruce Hassler, Mapleton, UT (US); Dane Dellenbach, Pleasant Grove, UT (US); John Graff, Provo, UT (US); Jacob Hutchings, Provo, UT (US); Kyle Stenson, Provo, UT (US)

(21) Appl. No.: 13/942,547

(22) Filed: Jul. 15, 2013

Related U.S. Application Data
(63) Continuation-in-part of application No. 13/348,221, filed on Jan. 11, 2012.
Application No. 13/348,221 is a continuation-in-part of application No. 13/924,372, filed on Jun. 21, 2013.

(51) Int. Cl. G06Q 50/26; G06Q 10/00

(52) U.S. Cl. CPC G06Q 50/265; G06Q 10/00
USPC 705/325

(57) ABSTRACT

The various implementations of the present invention are provided as a computer system configured to allow for sending requests for aid, responding to requests for aid, and receiving requests to aid in a multi-user environment. Various levels of requests may be requested. In one preferred embodiment of the present invention, a mobile application for integrating the options for requesting aid from a first device to a second is provided, as well as configuration of automated responses. The system allows certain users to post status updates to a website. While useful for many environments, the most preferred embodiments of the present invention are adapted for use in an educational environment to provide school administrators, teachers, parents, and students with enhanced communication capabilities.

### RELATED APPLICATIONS

This patent application is a continuation-in-part of U.S. patent application Ser. No. 13/924,372 which application was filed on Jun. 21, 2013, which application is now pending and which application is incorporate herein by reference. This patent application is also a continuation-in-part of U.S. patent application Ser. No. 13/348,221 which application was filed on Jan. 11, 2012, which application is now pending and which application is incorporate herein by reference.

### BACKGROUND OF THE INVENTION

1. Technical Field

The present invention relates generally to the field of communications and more specifically relates to systems and methods for creating an enhanced environment for sending requests for aid, receiving requests for aid, and providing aid during an emergency.

2. Background Art

Many individuals, such as teachers, parents, workers, managers, and employers, and organizations, such as schools and businesses will often find it useful to communicate during an emergency and to initiate a response during an emergency. Since communicating in the world today during an emergency encompasses much more than shouting down the hallway but now includes modes of communication such as messages sent to mobile devices, SMS, phone messages, and email messages, many entities are finding it increasingly difficult to maintain the desired level of communication during an emergency such as a roaming gunman or hurricane. Additionally, coordinating a quick response among the decision makers and security personnel of an organization or of an organization, such as a school district, and its sub-organizations, such as the schools in the school district, is difficult. The tragic shootings in Newtown, Conn. are just one example of the many situations where there is a need for technology to alert those in an organization that there is imminent danger and to facilitate remedial action.

Some of the main problems that hamper efforts to communicate during an emergency and to initiate a response to the emergency are that there are often many different people that should be alerted during an emergency, the time to alert the various people during an emergency before a tragic event occurs is often less than desirable, and the type of response that should be initiated in response to an emergency often vary depending on the nature of the emergency event.

Accordingly, without improvements in the current systems, procedures, and methods for communicating during an emergency, the ability to send a meaningful and appropriate communication to those that should be alerted in a timely manner and to initiate an appropriate response will be suboptimal.

### BRIEF SUMMARY OF THE INVENTION

The various implementations of the present invention are provided as a computer system configured to allow for communicating during an emergency and providing an optional response. The system focuses on a) providing responses to requestor-selected requests for a response which may be automated or may require confirmation by a human before initiating the response, b) receiving comments from requestors about the emergency, c) receiving GPS information, audio feeds, or video feeds from the requestor's device, d) receiving requests for a response to a high-priority emergency and initiating an appropriate response, e) receiving a request for a response to an emergency and initiating an appropriate response, f) notifying administrators who have authority with updates on the emergency situation, g) interacting with a user interface on a device to show the requests which have been acted upon and the requests which still have not yet been acted on, h) displaying a directory to show the status of the organizations and any sub-organizations, i) sending messages to predetermined groups in response to a request for help, and j) initiating the physical locking or unlocking of door locks.

In one preferred embodiment of the present invention, a mobile application for a requestor, such as a teacher or employee, to send a request an administrator to initiate a response to an emergency situation is provided. A user interface will allow the requestor to specify the type of emergency event and any comments which the requestor would like to send to emergency response personnel. Additional embodiments provide for a mobile application allowing an administrator to view and confirm requests from requestors.

While useful for many environments, the most preferred embodiments of the present invention are adapted for use in an educational environment to provide school administrators, teachers, parents, and students with enhanced communication and response capabilities.

### BRIEF DESCRIPTION OF THE FIGURES

The preferred embodiments of the present invention will hereinafter be described in conjunction with the appended drawings, wherein like designations denote like elements:

FIG. 1 is a schematic diagram of a computer-based system for an emergency response and for initiating a response in accordance with a preferred exemplary embodiment of the present invention;

FIG. 2 is a block diagram of a server used for implementing a computer-based system for receiving requests for aid and providing aid during an emergency in accordance with a preferred exemplary embodiment of the present invention;

FIG. 3. is a schematic drawing of a first smartphone 190 and a second smartphone 195 depicted in FIG. 1. (Although FIG. 1 shows a picture of a first smartphone 190 and a second smartphone 195, any type of electronic device which can communicate with network computer system 100 may be used.)

FIG. 4 is a flow chart of a method for implementing a computer-based system for receiving requests for aid and providing aid during a high-priority emergency, such as a request for a lockdown response to a gunman in a school, in accordance with a preferred exemplary embodiment of the present invention;

FIG. 5 is a flow chart of a method for implementing a computer-based system for receiving and responding to a request for a response to a high-priority emergency, such as a request for a lockdown response to a gunman in a school, in accordance with a preferred exemplary embodiment of the present invention;

FIG. 6A is a schematic representation of a user interface for sending a request for aid during an emergency created by a computer-based system in accordance with a preferred exemplary embodiment of the present invention.

FIG. 6B is a schematic representation of a user interface for sending a request for aid during an emergency created by a computer-based system in accordance with a preferred exemplary embodiment of the present invention.

FIG. 6C is a schematic representation of a user interface for sending a request for aid during an emergency created by a computer-based system in accordance with a preferred exemplary embodiment of the present invention.

FIG. 6D is a schematic representation of a user interface for sending a request for aid during an emergency created by a computer-based system in accordance with a preferred exemplary embodiment of the present invention.

FIG. 7A is a schematic representation of a user interface for receiving and responding to a request for aid during an emergency created by a computer-based system in accordance with a preferred exemplary embodiment of the present invention.

FIG. 7B is a schematic representation of a user interface for receiving and responding to a request for aid during an emergency created by a computer-based system in accordance with a preferred exemplary embodiment of the present invention.

FIG. 7C is a schematic representation of a user interface for receiving and responding to a request for aid during an emergency created by a computer-based system in accordance with a preferred exemplary embodiment of the present invention.

FIG. 7D is a schematic representation of a user interface for receiving and responding to a request for aid during an emergency created by a computer-based system in accordance with a preferred exemplary embodiment of the present invention.

FIG. 7E is a schematic representation of a user interface for receiving and responding to a request for aid during an emergency created by a computer-based system in accordance with a preferred exemplary embodiment of the present invention.

FIG. 7F is a schematic representation of a user interface for receiving and responding to a request for aid during an emergency created by a computer-based system in accordance with a preferred exemplary embodiment of the present invention.

FIG. 7G is a schematic representation of a user interface for receiving and responding to a request for aid during an emergency created by a computer-based system in accordance with a preferred exemplary embodiment of the present invention.

FIG. 7H is a schematic representation of a user interface for receiving and responding to a request for aid during an emergency created by a computer-based system in accordance with a preferred exemplary embodiment of the present invention.

FIG. 7I is a schematic representation of a user interface for receiving and responding to a request for aid during an emergency created by a computer-based system in accordance with a preferred exemplary embodiment of the present invention.

FIG. 7J is a schematic representation of a user interface for receiving and responding to a request for aid during an emergency created by a computer-based system in accordance with a preferred exemplary embodiment of the present invention.

FIG. 7K is a schematic representation of a user interface for receiving and responding to a request for aid during an emergency created by a computer-based system in accordance with a preferred exemplary embodiment of the present invention.

FIG. 7L is a schematic representation of a user interface for receiving and responding to a request for aid during an emergency created by a computer-based system in accordance with a preferred exemplary embodiment of the present invention.

FIG. 8 is a block diagram illustrating the components of a computer-based system for receiving and responding to a request for aid during an emergency.

### DETAILED DESCRIPTION OF THE INVENTION

The various implementations of the present invention are provided as a computer system configured to allow for receiving requests for aid and providing aid during an emergency. The system focuses on providing a user interface for a requestor, such as a teacher, to communicate to a superior, such as an administrator, the need for aid during an emergency, and for an administrator to initiate an appropriate response which includes communicating with various people in the organization and also may include communicating with the public. In one preferred embodiment of the present invention, a computer based-system is configured to communicate with at least one mobile application on a mobile device. In one preferred embodiment, the mobile application on the mobile device has a user interface which allows a requestor, such as a teacher, to request help in an emergency from an administrator, such as the principal or a computer. In one preferred embodiment of the present invention the administrator uses a mobile application on a mobile device to a) receive the request from the requestor, Additional embodiments provide for automated or semi-automated communication, that is an automated response occurs after an administrator has approved the request, enhanced communication selection by using variables such as severity of the emergency, location of the requestor, name of the requestor, and time of day. While useful for many environments, the most preferred embodiments of the present invention are adapted for use in an educational environment to provide school administrators, teachers, parents, and students with enhanced capabilities for requesting aid, receiving requests for aid, and providing aid during an emergency. Some embodiments include a computer-based system which interacts with mobile applications software executed on a mobile device; some embodiments include a computer-based system which interacts with software executed on a non-mobile devices such as a desktop accessing a website; some embodiments include a computer-based system as well as the software which interacts with the computer-based system and is executed on either mobile devices or non-mobile devices.

The various preferred embodiments are specifically designed to provide for a requestor, such as an employee, who uses software in conjunction with an electronic device, such as a mobile device, which can be used to send notifications to an administrator, such as the employee's supervisor. The various preferred embodiments are specifically designed to be used by various entities including schools, community groups, commercial enterprises, municipalities, and government agencies to send and receive communications about the existence of an emergency situation, the nature of the emergency situation such as whether it is a high priority emergency, a low priority emergency, a proposed lockdown situation, a proposed panic situation, etc, and to initiate a response. Specifically, some of the disclosed embodiments provide for a user interface for requestors to efficiently send an alert about an emergency event by pressing a button on the user interface which corresponds to the type of the emergency or the type of response which is requested.

Aspects of the computer-based system for sending requests for aid, receiving requests for aid, and providing aid during an emergency are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Additionally, various preferred embodiments of the program product may be configured to: create and modify multiple databases; track, update and store data relative to requests and responding to requests; configure and implement various search and retrieve functions for a multitude of search requests and determinations made by users of the computer-based system for receiving requests and responding to emergencies; track and store information about various requests and responses to requests; update and transmit reports on the type of requests which have been submitted by requestors and the types of responses to requests for aid which have been initiated; and provide one or more user interfaces for accomplishing all of these functions.

In this fashion, the appropriate entities (i.e., business owners, managers, administrators, teachers, parents, students, etc.) can utilize the program product to initiate and complete a wide variety of database-related applications for the provision of requests for aid and for initiating responses to requests for aid during a perceived emergency situation or an actual emergency situation. Similarly, a program product in accordance with one or more preferred embodiments of the present invention can also be configured to perform substantially all of the steps depicted and described in conjunction with the figures below for implementing a system for sending requests for aid, receiving requests for aid, and providing aid during an emergency as described herein.

It should also be noted that several preferred embodiments of the present invention discuss the use of mobile application software executed by a mobile device. In all of these cases, the use of mobile application software executed by a mobile device is optional and may or may not be used for sending and receiving requests for aid and for. In some embodiments, administrators and requestors use software accessed via a browser on a desktop or laptop to send and receive requests for aid and for providing aid such as notifying a group of first responders about the emergency. While the present invention will be described in detail by using various examples of a typical educational environment, those skilled in the art will recognize that the equipment, processes, methods and techniques described herein have broad applicability to other environments and applications where quick and efficient capabilities for sending requests, for receiving requests for aid and for providing aid during an emergency.

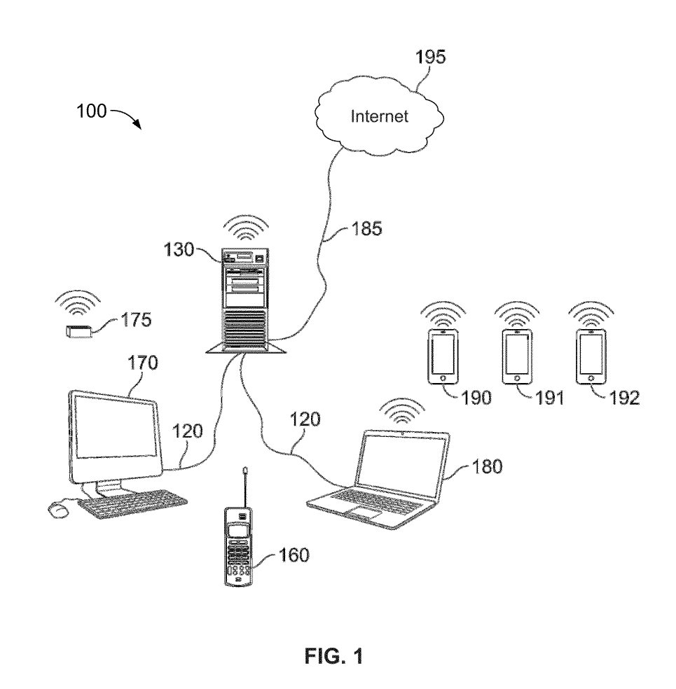

Referring now to FIG. 1, a computer-based system for receiving requests for aid, providing aid during an emergency, and sending requests for aid 100 in accordance with a preferred exemplary embodiment of the present invention comprises: a data server 130; at least one of a desktop computer 170 or a laptop computer 180; a telephone 160; a wireless communication device 175; and an optional smartphone or Personal Digital Assistant 190 and an optional second smartphone of second Personal Digital Assistant 1900 all connected or coupled via a local area network 120 to the Internet 195 via an Internet connection 185.

In the most preferred embodiments of the present invention, network computer system 100 is configured as a system that will be used for sending requests for aid, receiving requests for aid, and providing aid during an emergency. In this preferred embodiment, the group of users for network computer system 100 will typically include administrators for individual schools as well as school board and school district officials, teachers, staff, public relations personnel, community members, parents, and students.

Network 120 represents any suitable computer communication link or similar communication mechanism, including some combination of a hardwired connection, an internal or external bus, a connection for telephone access via a modem, standard co-axial cable lines, high-speed T1 line, radio, infrared or other wireless communication methodologies (i.e. “Bluetooth,” infrared (IR), etc.), private or proprietary local area networks (LANs) and wide area networks (WANs), as well as standard computer network communications over Internet 195 or an internal network (e.g. “intranet”) via a wired or wireless connection, or any other suitable connection between computers and computer components known to those skilled in the art, whether currently known or developed in the future. It should be noted that portions of network 120 might suitably include a dial-up phone connection, a broadcast cable transmission line, a Digital Subscriber Line (DSL), an ISDN line, or similar public utility-like access link.

In the most preferred embodiments of the present invention, at least a portion of network 120 comprises a standard Internet connection 185 between at least some of the components of network computer system 100 for providing access to additional network resources and other remote locations. Network 120 provides for communication between the various components of network computer system 100 and allows for relevant information to be transmitted from device to device. In this fashion, a user of network computer system 100 can quickly and easily gain access to the relevant data and information utilized to search, retrieve, and display information from one or more databases as described in conjunction with the preferred embodiments of the present invention.

In the most preferred embodiments of the present invention, network 120 is configured to provide relatively high-speed transmission of textual information, audio and video data and signals, and also comprises at least an Internet connection 185 for transmission of data captured by one or more computers 170 or 180 and a phone 160 for transmission of an audio signal to and from a standard phone connection. The phone connection may be interfaced to a standard phone system typically found in most homes and commercial facilities, including for example, the existing “land line” phone system infrastructure and/or digital cellular phone communication systems.

In addition to the other components shown in FIG. 1, a wireless communication access device 175 may be communicatively coupled to network 120 and may be any type of wireless communication mechanism that is known to those skilled in the art to provide for wireless communication between network 120 and the various devices associated with network 120, including desktop computer 170, laptop computer 180 and phone 160 as well as smart phone 190. The most preferred embodiments of an acceptable wireless communication access device may comprise any type of wireless bridge, wireless router, or wi-fi “hotspot.”

Regardless of the specific components, physical nature, and topology, network 120 serves to logically and communicatively link the physical components of network computer system 100, thereby enabling stable and consistent communication between the components. This is especially important because in many preferred embodiments of the present invention, data server 130, desktop computer 170, and laptop computer 180 may be geographically remote and/or physically separated from each other.

Data server 130 represents a relatively powerful computer system that is made available to desktop computer 170, laptop computer 180, and/or phone 190 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 130. Data server 130 may also provide various additional software components (not shown this FIG.) such as database servers, web servers, firewalls, security software, and the like. The use of these various hardware and software components is well known to those skilled in the art.

Given the relative advances in the state-of-the-art computer systems available today, it is anticipated that functions of data server 130 may be provided by many standard, readily available data servers. This may also include the deployment of multiple inter-connected and redundant data servers 130 to enhance the availability and reliability of the functions provided by data server 130. Depending on the desired size and relative power required for data server 130, storage area network (SAN) technology may also be deployed in certain preferred embodiments of the present invention. Additionally, various biometric and identification verification devices for identifying users and controlling access as well as creating and verifying digital signatures (i.e., electronic signature processing) may also be included.

Desktop computer 170 may be any type of computer system known to those skilled in the art that is capable of being configured for use with network computer system 100 as described herein. It should be noted that no specific operating system or hardware platform is excluded and it is anticipated that many different hardware and software platforms may be configured to create computer 170. As previously explained in conjunction with data server 130, various hardware components and software components (not shown this FIG.) known to those skilled in the art may be used in conjunction with computer 170. It should be noted that in the most preferred embodiments of the present invention, desktop computer 170 is linked (via wired or wireless connection) to its own LAN or WAN and has access to one or more additional data servers (not shown this FIG.).

In addition as shown in FIG. 1, a telephone 160 may be used in conjunction with computer 170 to allow audio messages and alerts to be communicated to telephone 160. In this application, telephone 160 has been communicatively coupled to or otherwise interfaced with the standard telephone communication infrastructure associated with one or more users of network computer system 100. Similarly, audio messages and various other communications and alerts may be communicated to smartphone 190.

Similarly, laptop computer 180 may be any type of relatively lightweight portable computer system known to those skilled in the art that is capable of being configured for use with network computer system 100 as described herein. This includes tablet computers (e.g., iPad®), pen-based computers and the like. Computer 180 may also be configured to allow the transmission and reception of audio signals, messages, communications, and various types of alerts via server 130 and network 120.

Additionally, netbooks, tablets, handheld and palmtop devices are also specifically included within the description of devices that may be deployed as a laptop computer 180. It should be noted that no specific operating system or hardware platform is excluded and it is anticipated that many different hardware and software platforms may be configured to create laptop computer 180. As previously explained in conjunction with data server 130, various hardware and software components (not shown this FIG.) known to those skilled in the art may be used in conjunction with laptop computer 180. It should also be noted that in the most preferred embodiments of the present invention, laptop computer 180 is linked to its own LAN or WAN and has access to its own data server (not shown this FIG.).

In general, the communication between devices associated with data server 130 will be data associated with sending requests for aid, receiving requests for aid, and providing aid during an emergency. The users of desktop computer 170 and/or laptop computer 180 may be program administrators, managers, teachers, community members, parents and students who are seeking to access requests for aid from requestors, such as teachers facing a gunman. Additionally, in some embodiments, mobile devices are used instead of desktop computers 170 and/or laptop computer 180.

Additionally, various related entities such as local and regional governments, commercial enterprises, municipalities, and their employers and agents may also have access to one or more databases located on data server 130 via desktop computer 170 and/or laptop computer 180.

It should be noted that while FIG. 1 shows only a single desktop computer 170 and a single laptop computer 180, it is anticipated that the most preferred embodiments of the present invention will comprise dozens or even hundreds of computers 170 and laptop computers 180. Each of these computers 170 and 180 will be configured to access data server 130 in an appropriately secure way so as to accomplish the specific objectives of the user of the desktop computer 170 or laptop computer 180.

For example, the service provider that controls the databases stored on data server 130 may utilize desktop computer 170 or laptop computer 180 to access data server 130 and create, update or otherwise modify a given database. An operator, located in a remote location, may use desktop computer 170 or laptop computer 180 to access data server 130 to retrieve information about the participants or persons and the requests being transmitted by the users of network computer system 100 and the responses to requests being transmitted by the users of the network computer system 100.

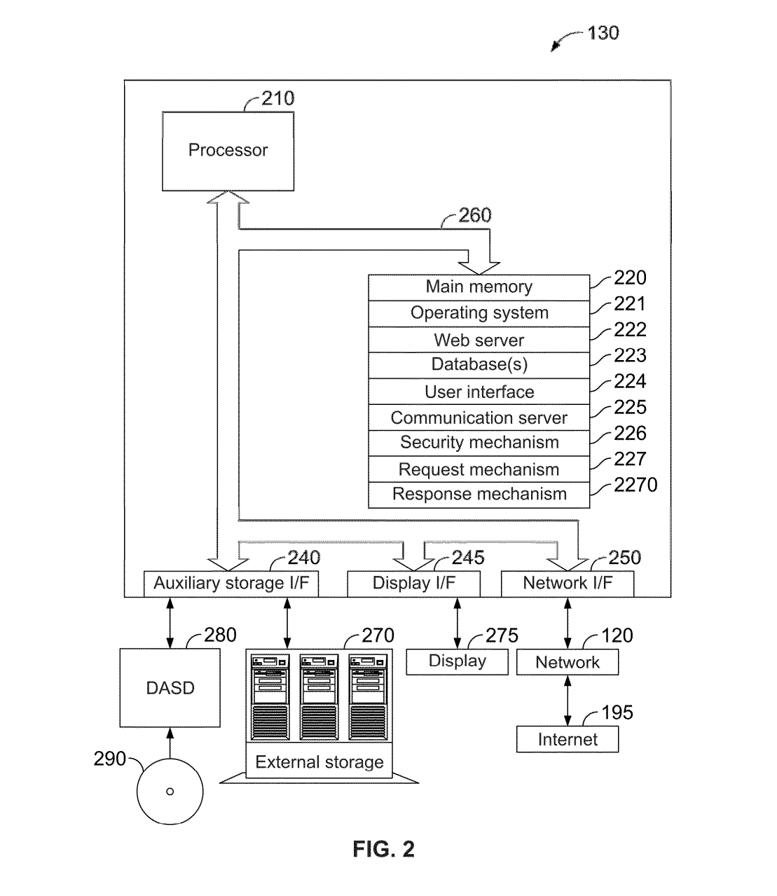

In the most preferred embodiments of the present invention, multiple desktop computers 170 and multiple laptop computers 180 will all be configured to communicate simultaneously with data server 130 and with each other via network 120. In addition, the most preferred embodiments of the present invention include an Application Service Provider (ASP) environment where data server 130 may be operated as a clearinghouse in a hosted operation. In this fashion, multiple desktop computers 170 and laptop computers 180 will have access to data server 130 and the databases stored thereon via a global computer network such as Internet 195. Data server 130 is further described below in conjunction with FIG. 2 below.

An optional printer and an optional fax machine (not shown this FIG.) may also be deployed for various hard copy data output requirements and may be considered to be any standard peripheral devices used for transmitting or outputting paper-based documents, notes, transaction details, reports, etc. in conjunction with the various requests and transactions processed by network computer system 100 (e.g., reports, communications, statistical analyses, automated letters, etc.) Finally, it should be noted that the optional printer and the optional fax machine are merely representative of the many types of peripherals that may be utilized in conjunction with network computer system 100. It is anticipated that other similar peripheral devices will be deployed in the various preferred embodiment of the present invention and no such device is excluded by its omission in FIG. 1.

Smartphone 190 is representative of any type of cellular device or telephone that may be communicatively coupled to network computer system 100. This includes, for example, personal digital assistants (“PDAs”), Windows® mobile phone devices, Android®OS devices, Palm® OS devices, Pocket PC® devices, the Apple® iPhone® and other various types of smartphones. Those skilled in the art will recognize these various devices and others that are suitable for deployment as phone 190. While somewhat less powerful than computers 170 and 180, smartphone 190 may also be configured to wirelessly communicate with data server 130 via network 120 to send and retrieve tracking and messaging services related information to and from data server 130.

Given the standard functionality for devices that may be deployed as phone 190, this communication be provided by a wireless Internet connection (e.g. “wi-fi” or “wi-max”) or a Bluetooth® connection. One example of the use for smartphone or PDA 190 in the context of network computer system 100 would to send communications, messages or alerts to a parent of a student, alerting the parent of important information regarding the educational community and surrounding activities.

Those skilled in the art will recognize that FIG. 1 depicts a fairly standard “client/server” type communication arrangement where data server 130 is considered to be a server and computers 170 and 180 are considered to be clients of data server 130. Additionally, those skilled in the art will recognize that the functionality of data server 130 may be deployed on either of computers systems 170 and 180 in a more traditional “stand-alone” environment. In either case, the methods of the present invention are designed to minimize the amount of data that must be transferred from a database to the user of network computer system 100.

Referring now to FIG. 2, data server 130 of FIG. 1 in accordance with a preferred embodiment of the present invention represents one of many commercially available computer systems such as a Linux®-based computer system, an IBM® compatible computer system, or a Macintosh® computer system. However, those skilled in the art will appreciate that the methods and system of the present invention apply equally to any computer system, regardless of the specific operating system and regardless of whether the computer system is a more traditional “mainframe” computer, a complicated multi-user computing device or a single user device such as a personal computer or workstation.

Data server 130 suitably comprises at least one Central Processing Unit (CPU) or processor 210, an auxiliary storage interface 240, a display interface 245, and a network interface 250, all of which are interconnected via a system bus 260. Note that various modifications, additions, or deletions may be made to data server 130 illustrated in FIG. 2 within the scope of the present invention such as the addition of cache memory or other peripheral devices. FIG. 2 is not intended to be exhaustive, but is presented to simply illustrate some of the more salient features of data server 130.

Processor 210 performs computation and control functions of data server 130, and most preferably comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor or CPU. Processor 210 is configured to execute one or more software programs contained within main memory 220. Although data server 130 depicted in FIG. 2 contains only a single main processor 210 and a single system bus 260, it should be understood that the present invention applies equally to computer systems having multiple processors and multiple system buses. Similarly, although system bus 260 of the preferred embodiment is a typical hardwired, multi-drop bus, any connection means that supports bi-directional communication in a computer-related environment could be used.

Auxiliary storage interface 240 allows data server 130 to store and retrieve information from auxiliary storage devices, such as external storage mechanism 270, magnetic disk drives (e.g., hard disks or floppy diskettes) or optical storage devices (e.g., CD-ROM). One suitable storage device is a direct access storage device (DASD) 280. As shown in FIG. 2, DASD 280 may be a DVD or CD-ROM drive that may read programs and data from a DVD or CD disk 290.

Display interface 245 is used to directly connect one or more displays 275 to data server 130. Display 275, which may be non-intelligent (e.g., “dumb”) terminals or fully programmable workstations, are used to provide system administrators and users the ability to communicate with data server 130. Note, however, that while display interface 245 is provided to support communication with one or more displays 275, computer data server 130 does not necessarily require a display 275, because all needed interaction with users and other processes may occur via network 120. Additionally, in certain preferred embodiments, data server 130 may have an integrated display 275.

Network interface 250 is used to connect data server 130 to network 120 and network computer system 100, including computer 170 and computer 180 of FIG. 1. Network interface 250 broadly represents any suitable way to interconnect electronic devices, regardless of whether the network comprises present day analog and/or digital techniques or via some networking mechanism of the future. Network interface 250 preferably includes a combination of hardware and software that allows communications on network 120.

Software provided in conjunction network interface 250 preferably includes a communication manager that manages communication with other computer systems or other network devices via network 120 using a suitable network protocol. Many different network protocols can be used to implement a network. These protocols are specialized computer programs that allow computers to communicate across a network. TCP/IP (Transmission Control Protocol/Internet Protocol) is just one example of a suitable network protocol that may be used by the communication manager contained within network interface 250.

It is important to note that while the present invention has been (and will continue to be) described in the context of a fully functional computer system with certain application software, those skilled in the art will appreciate that the various software mechanisms of the present invention are capable of being distributed as a program product in conjunction with an article of manufacture comprising software stored on a computer readable storage medium in a variety of forms, and that the various preferred embodiments of the present invention applies equally regardless of the particular type or storage medium used to actually carry out the distribution. Examples of computer readable storage media include: non-transitory recordable type media such as DVD and CD ROMS disks (e.g., disk 290), and transmission type media such as digital and analog communication links, including wireless communication links.

Main memory 220 suitably contains an operating system 221, a web server 222, one or more databases 223, a user interface 224, a communication server 225, a security mechanism 226, a request mechanism 227, and a response mechanism 2270. The term “memory” as used herein refers to any storage location in the virtual memory space of data server 130 or on a data storage device.

It should be understood that main memory 220 might not necessarily contain all parts of all components shown. For example, portions of operating system 221 may be loaded into an instruction cache (not shown) for processor 210 to execute, while other files may well be stored on magnetic or optical disk storage devices (not shown). In addition, although database 223 is shown to reside in the same memory location as operating system 221, it is to be understood that main memory 220 may consist of multiple disparate memory locations. It should also be noted that any and all of the individual software mechanisms or components shown in main memory 220 might be combined in various forms and distributed as a stand-alone program product. Finally, it should be noted that additional software components, not shown in this figure, might also be included.

Operating system 221 includes the software that is used to operate and control data server 130. In general, processor 210 typically executes operating system 221. Operating system 221 may be a single program or, alternatively, a collection of multiple programs that act in concert to perform the functions of an operating system. Any operating system now known to those skilled in the art or later developed may be considered for inclusion with the various preferred embodiments of the present invention.

Web server 222 may be any web server application currently known or later developed for communicating with web clients over a network such as the Internet. Examples of suitable web servers 222 include Apache web servers, Linux web servers, and the like. Additionally, other vendors have developed or will develop web servers that will be suitable for use with the various preferred embodiments of the present invention. Finally, while depicted as a single device, in certain preferred embodiments of the present invention web server 222 may be implemented as a cluster of multiple web servers, with separate and possibly redundant hardware and software systems. This configuration provides additional robustness for system uptime and reliability purposes. Regardless of the specific form of implementation, Web server 222 provides access, including a user interface, to allow individuals and entities to interact with graphical user interface 224, including via network 120 of FIG. 1.

Database 223 is representative of any suitable database known to those skilled in the art. In the most preferred embodiments of the present invention, database 223 is a Structured Query Language (SQL) compatible database file capable of storing information relative to various items that may be of interest to the users of network computer system 100 of FIG. 1. In the most preferred embodiments of the present invention, database 223 will comprise a plurality of information that may be useful to an organization or individual that wants to send requests for aid, receive requests for aid, and provide aid during an emergency, in conjunction with a preferred embodiment of network computer system 100 of FIG. 1.

Graphical user interface 224 is a software component that provides the users of network computer system 100 of FIG. 1 a means for interacting with the various components of network computer system 100. In the most preferred embodiments of the present invention, graphical user interface 224 is a web browser based interface, accessible to the users of network computer system 100 via any standard web browser from any computer that is connected to the Internet. Additional details on graphical user interface 224 are presented below.

In at least one preferred embodiment for sending requests for aid, receiving requests for aid, and providing aid during an emergency, database 223 will typically include a plurality of database records containing information about multiple organizations, sub-organizations (such as the schools belonging to a school district), the name of a location and the GPS coordinates for locations (such as a classroom) within an organization or sub-organization, administrators, and potential requestors, e.g. someone authorized to send in request but has not yet sent in a request, categories for a request (such as a high priority emergency category, a low priority emergency, a lockdown emergency, a panic emergency, a snow storm, an earthquake), responses to requests which may be specific action plans which may include groups of persons to be notified, priority schedules for which groups of individuals are notified first, plans for locking specific doors in the physical facilities of an organization or a suborganization, plans for contacting first responders and the necessary information to carry out the plan; responses may include the triggers which need to be triggered before a response plan is activated, such as the computer-based system implements response plan A when an authorized requestor has sent a request for a lockdown and an administrator has confirmed the request by selecting a “Confirm Request” button of a user interface displayed on the administrator's mobile device.

In addition, even if the actual information used to implement a response or portions of a response to a request is not stored in database 223, the parameters and requirements for implementing a response to a request, provided by unaffiliated entities, may also be stored and maintained in database 223. As used herein a requestor is someone or something, such as a computer, which is authorized by network computer system 100 to make requests. This includes detailed information about each requestor or group of requestors, including permissions, etc. In this fashion, an administrator with access to database 223 will be provided with the capability of implementing a response to a request

In at least one preferred embodiment of the present invention, administrators, such as school administrators or employees of a city who manage other employees, can add relevant information to database 223 of FIG. 2 in order to configure the manner in which requestors send requests and the manner of the response. In some embodiments, administrators can configure the database 223 of FIG. 2 in order to determine what actions by requestors will trigger a response and the nature of such a response. For example, an administrator may configure database 223 of FIG. 2. So that requestors are presented 23 or more tiers of request for emergency help such as a lockdown request for a school, a panic request for a school, and an emergency request for help. Administrators may also configure the database 223 so that it initiates a response when the network computer system 100 has received a request from requestor. For example, network computer system 100 can be configured so that when it receives a request for a response to a high priority emergency, such as a lockdown request, it initiates an automatic response.

Those skilled in the art will recognize that other types of information for other types of data that may be used in other applications (e.g., historical, informational, technical, etc.) may be stored and retrieved as well. While database 223 is shown to be residing in main memory 220, it should be noted that database 223 might also be physically stored in a location other than main memory 220. For example, database 223 may be stored on external storage device 270 or DASD 280 and coupled to data server 130 via auxiliary storage I/F 240. Additionally, while shown as a single database 223, those skilled in the art will recognize the database 223 may actually comprise a series of related databases, logically linked together. Depending on the specific application and design parameters, database 223 may take many different forms when implemented.

The most preferred embodiments of network computer system 100 of FIG. 1 will typically include a communication server 225 in main memory 220. Communication server 225 is an automated programmable system that is capable of generating one or more forms of messages or message events. For example, communication server 225 may be configured to send automated email messages or SMS text messages to cell phones. Communication server 225 may also be used to generate hard copy messages (e.g., mail merge letters) that are then sent via standard U.S. Postal Service or some type of commercial message delivery company.

However, in the most preferred embodiments of the present invention, communication server 225 will be configured to provide messages based on user preferences. As used herein, a user is anyone who uses network based computer system 100, such as a requestor, an administrator, an intended recipient, or an employee. Each user may have an account and their account information may be stored in database 223 of FIG. 2. It should be noted that the output from communication server 225 may be determined based on user preferences maintained in conjunction with each user's account. Each user may select message delivery preferences via user interface 224. For example, if a intended recipient, such as a teacher at a school who does not make a request but would benefit from receiving a message about an emergency situation, prefers to receive a a message via a push notification, then the intended recipient may use user interface 224 or user interface 9004 to configure its delivery preferences and then communication server 225 will transmit message to the user via email. Additionally, communication server 225 may be configured to generate a facsimile message by utilizing fax server and a facsimile modem (not shown this FIG.) that is contained in data server 130 of FIG. 2. Communication server 225 is also capable of being configured and used to send and receive various electronic status messages (e.g. audio and video alerts) and updates to data server 130 and between computers 170, 180, and/or 190 of FIG. 1, as may be necessary to enhance the overall process of completing activities related to the provision of sending requests for aid, receiving requests for aid, and providing aid during an emergency.

It is anticipated that communication server 225 will be configured to generate and transmit various messages that contain a plurality of audio files or “clips” where each audio message event may contain multiple discrete elements. For example, each message may contain standardized pre-recorded audio clips; audio clips generated by an automated text-to-speech computer program, and contemporaneously recorded audio clips that are unique to a specific message. Additionally, dynamic audio clips, using elements extracted from database 223, that are associated with a specific individual, may also be included in a message. For example, a generic introduction or greeting from the supervisor or teacher associated with a specific individual may be included, a facility identifier (e.g., school, factory, or office building location associated with the at least one individual), as well as the purpose for sending the message (e.g. expression of concern, encouraging message, etc.).

In addition, most preferred embodiments of the present invention would include a security and/or encryption mechanism 226 for verifying access to the data and information contained in and transmitted to and from data server 130. Security mechanism 226 may be incorporated into operating system 221 and/or web server 222. Additionally, security mechanism 226 may also provide encryption capabilities for other components of network computer system 100 of FIG. 1, thereby enhancing the robustness of network computer system 100 of FIG. 1. Security mechanism 226 is most preferably configured to protect the integrity and security of the information transmitted via network 120 of FIG. 1.

Further, depending on the type and quantity of information stored in database 223 and accessed by graphical user interface 224, security mechanism 226 may provide different levels of security and/or encryption for different computer systems 170 and 180 of FIG. 1 and the information stored in database 223. The level and type of security measures applied by security mechanism 226 may be determined by the identity of the end-user and/or the nature of a given request and/or response. In some preferred embodiments of the present invention, security mechanism 226 may be contained in or implemented in conjunction with certain hardware components (not shown this FIG.) such as hardware-based firewalls, switches, dongles, and the like.

Request mechanism 227 may be a software program or mechanism that identifies, collects and optionally displays to an administrator some or all requests which have been submitted by a requestor. Request mechanism 227 may store the data contained in the requests in database(s) 223 and may use the data to create charts or tables of the requests or may communicate with response mechanism 2270. Response mechanisms 2270 may be a software program or mechanism which follows predetermined rules for initiating responses to requests, such as sending a message to groups of intended recipients, which may be a group of all employees working at a school who should be notified during a lockdown situation. The predetermined rules may be stored as defaults on network computer system 100 or may be configured by administrators using user interface 224 or user interface 9002. The predetermined rules may contain instructions for network computer system 100 to initiate and complete an automatic response to a request; alternatively the predetermined rules stored on database 223 may instruct response mechanisms 2270 to send a message to an administrator with a suggested response event, to wait for the administrator to sending a confirming message via user interface 224 or user interface 9002, and then initiate the response event aft3er receiving the confirming message also referred to herein as a confirmation.

In the most preferred embodiments of the present invention, the various components of network computer system 100 of FIG. 1 are able to communicate using multiple communications protocols and systems (e.g., Voice over IP or “VoIP”, Plain Old Telephone Service or “POTS”, etc.). Those skilled in the art will recognize that the communication protocols used herein may be readily adapted and configured to allow for the rapid and efficient transmission and receipt of data by and between the various components of network computer system 100 of FIG. 1. This would also include the ability to control and customize the input and output of network computer system 100 of FIG. 1 for integration with other systems. While a specific exemplary embodiment of a suitable server 130 has been provided above, those skilled in the art will recognize that many other suitable computers (with more or fewer features) may be substituted for the specific example provided herein within departing from the spirit and scope of the present invention.

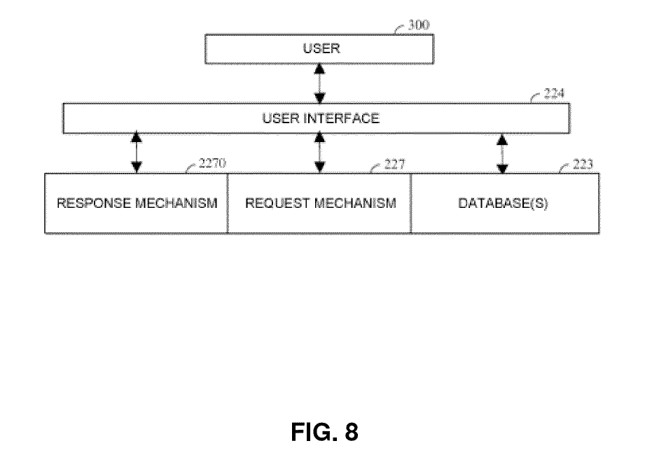

Referring now to FIG. 2 and FIG. 8, an administrator will interact with user interface 224. By accessing user interface 224, administrator can input and modify the data contained in database(s) 223. Administrator can also interact with and configure request mechanism 227 and response mechanism 2270.

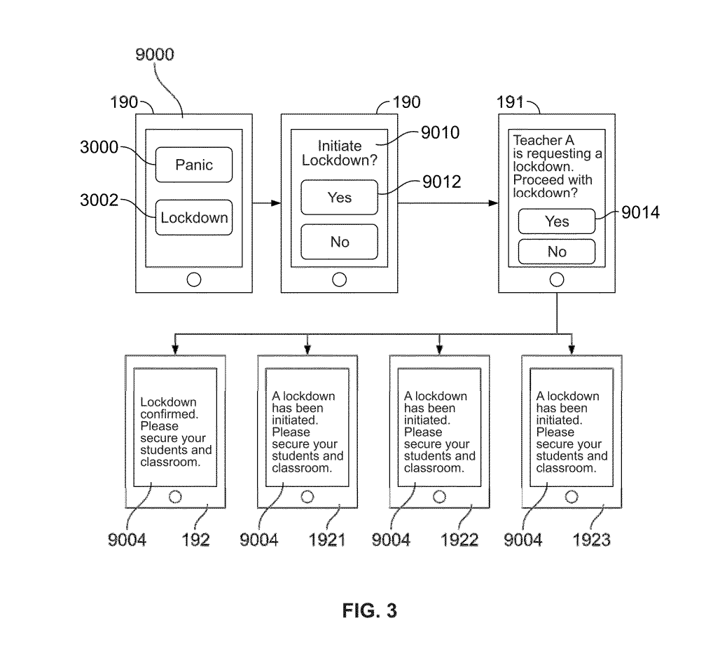

Referring now to FIG. 3, FIG. 3 is a schematic drawing of a first smartphone 190 and a second smartphone 195 depicted in FIG. 1.

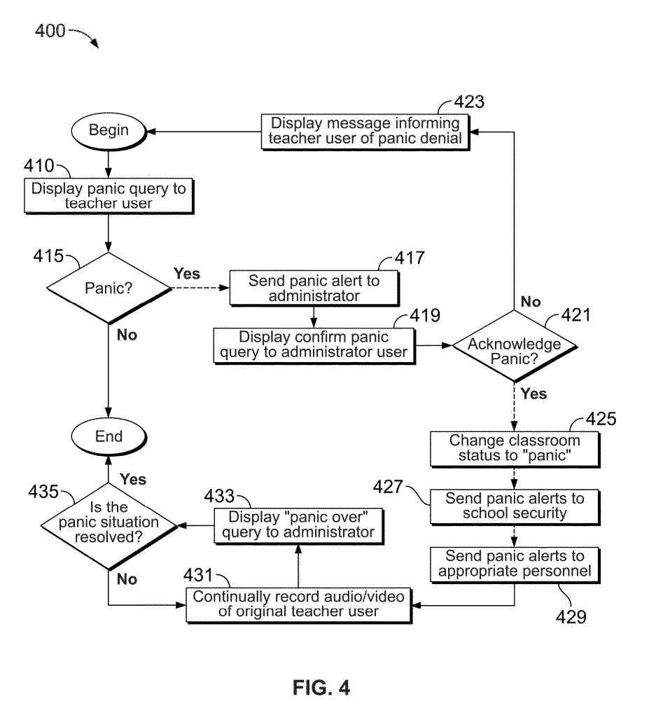

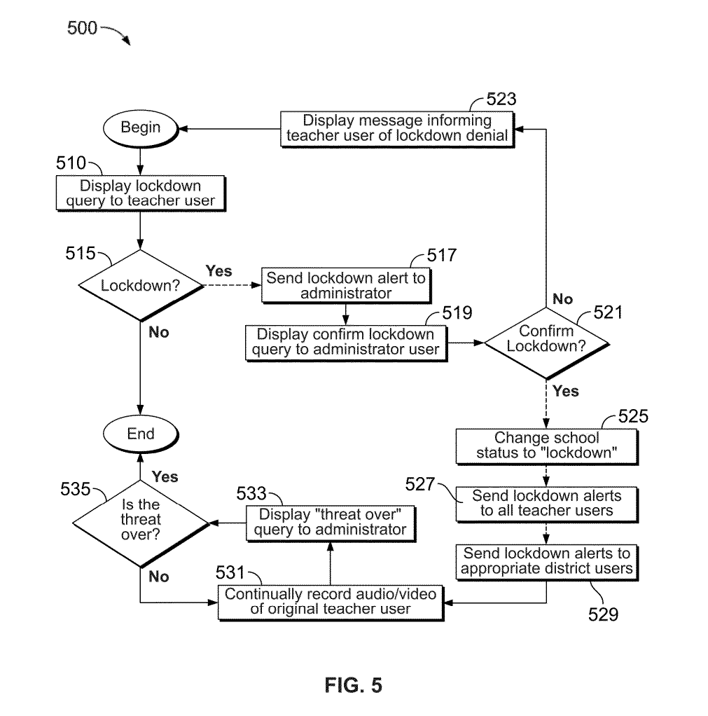

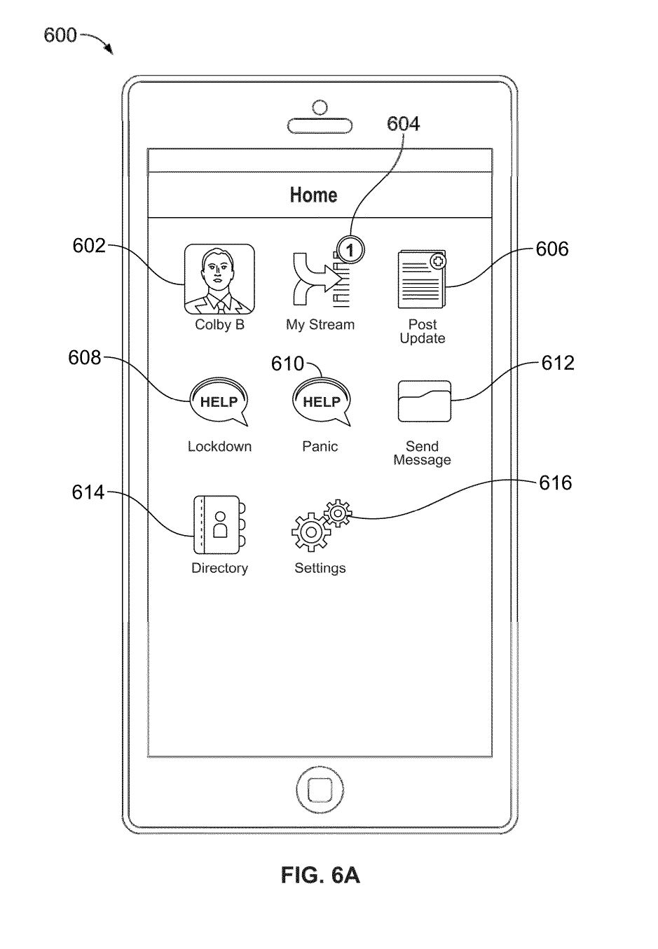

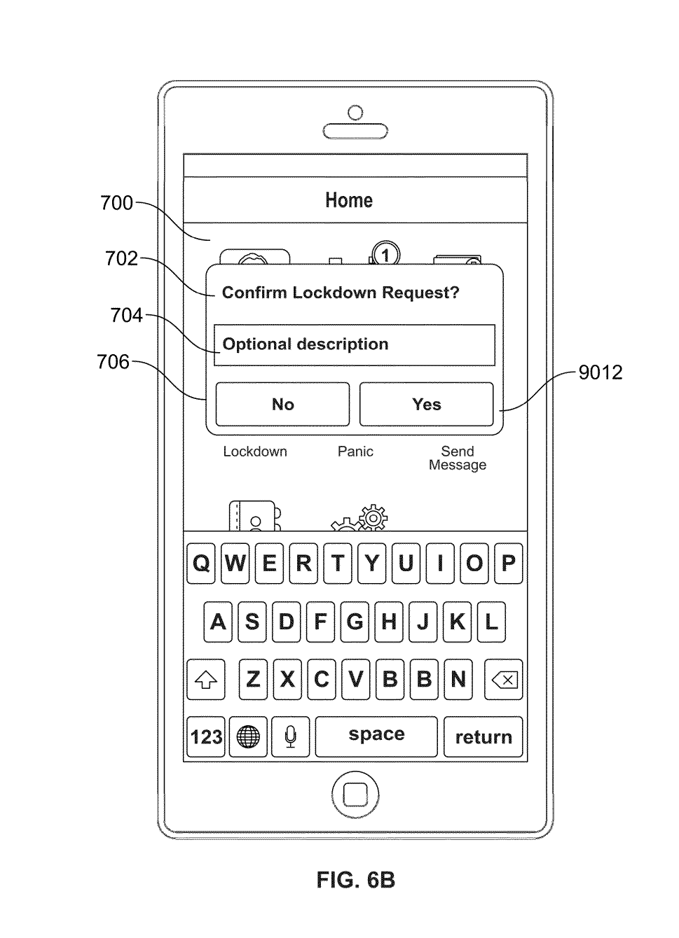

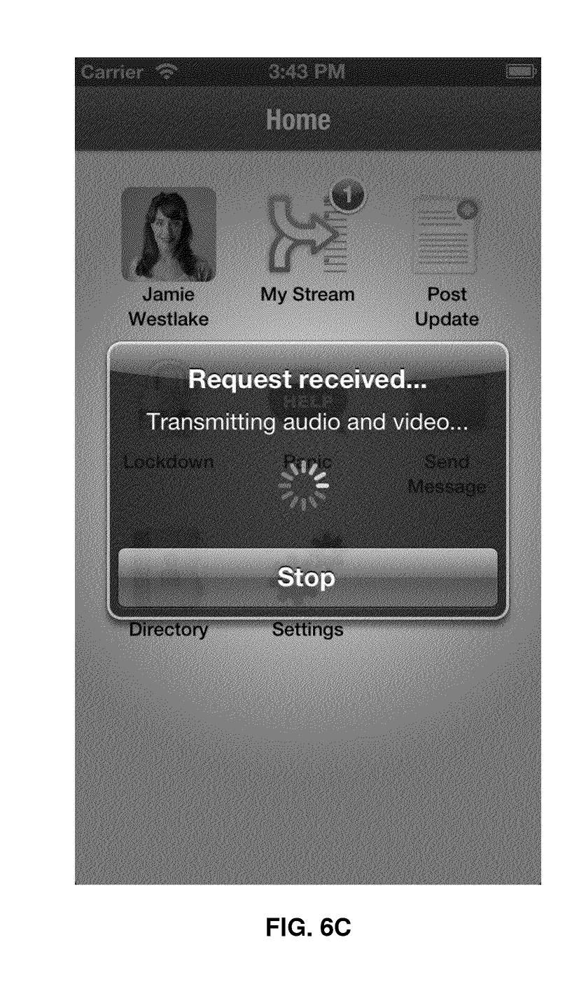

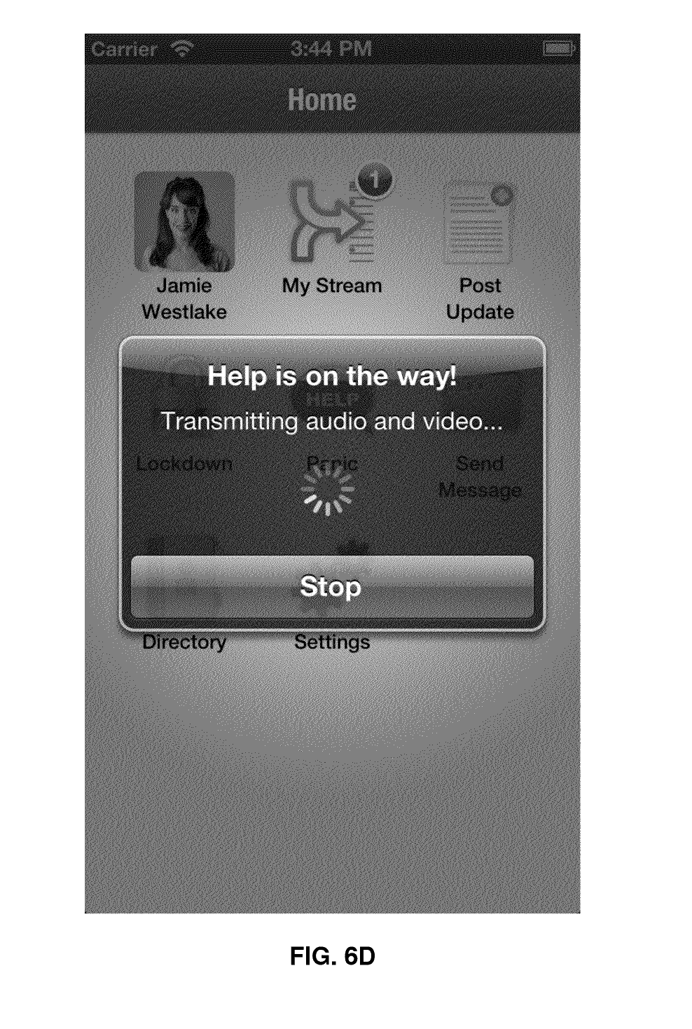

As shown in FIG. 3, a graphical user interface 9000 is provided via smartphone 190 for a requestor to send a request via a smartphone “app.” User interface 9000 provides a plurality of icons; in this example, when panic icon 3000 is selected, the smartphone app of smartphone 190 will send an instruction via network 120 to network computer system that the requestor has sent a request for a response to a lower priority emergency, such as when two student are fighting. Network computer system 100 may then initiate a response as shown in FIG. 4. After an administrator has selected lockdown icon 3002, the smartphone app of smartphone 190 will then display a confirmation page 9010, which is disclosed in further detail in FIG. 6B. After an administrator has selected “yes” on the lockdown request on the confirmation display 9012 for a lockdown request, the smartphone app of smartphone 190 sends a communication to network computer system 100 and network computer system 100 then sends an instruction to smartphone 191 of an administrator to display a confirm lockdown query, as disclosed in step 519 of FIG. 5. In some preferred embodiments, the system is further configured to perform certain predetermined automated actions as part of the lockdown response upon selection of icon 9012. These are immediate initial actions that do not require confirmation from the administrator and can be performed solely on the authorization of the requestor. Some examples of the automatic actions that the system can be configured to take are locking certain doors, messaging certain personnel such as security, or turning on proximate water sprinkler systems. In most preferred embodiments the system is configured to store and perform separate and different sets of actions to take for each type of emergency request type. Some actions may require a higher permission, and the system will not perform those actions until it has received confirmation of the request from an administrator with the required level of permission.

In most preferred embodiments, more information is received along with the emergency response request from the smartphone 190 upon selection of icon 9012. This could include the name of the user, the time of the request, and the location of the device using the device's internal or connected GPS mechanism. The network computer system sends this information to be displayed on the administrator's smartphone 191 along with the confirmation query. When an administrator selects the yes confirmation icon 9014 for a lockdown request displayed in user interface 9002 of a second smartphone 191 used by an administrator, the smartphone app sends an instruction to network computer system 100 to initiate a lockdown response. Network computer system 100 responds in this example by sending a message to smartphone 192 of an intended recipient, smartphone 1921 of an intended recipient, smartphone 1922 of an intended recipient, and smartphone 1923 of an intended recipient. Some embodiments send out messages in tiered groups. The system is configured to send out a first message to a first group saved in the database, and then to send a second message to a second group. This would allow a quick message to be sent to all staff before then sending a message to the public. The system can be configured to delay the sending of the second message for a certain amount of time, or until it is approved by another individual. Some embodiments will include an organization communication specialist or other public relations officer in the first group, and they will create and configure the second message that will then be sent to the public such as the parents of the students. Other examples of possible actions to be included in a lockdown response are calling 911, playing a voice recording stating the nature or the status of an emergency, closing fire door and turning on emergency ventilation systems. In some embodiments the step of confirmation by an administrator is optional and a request for a lockdown or other type of emergency response can result in network computer system automatically sending messages to smartphones of intended recipients such as smartphone 192 of an intended recipient or perform any other action included in the lockdown response.

Referring now to FIG. 4, an overall process and method 400 for receiving and responding to a request for aid during an emergency in accordance with a preferred embodiment of the present invention is shown. In the most preferred embodiments of the present invention, method 400 is a computer-implemented method used in conjunction with the hardware and software described in conjunction with FIG. 1, FIG. 2, and FIG. 8.

As shown in FIG. 4, the first step will generally display a panic query to an intended recipient, such as a teacher user (step 410). As used herein, a panic query refers to a query for which a requestor wishes to initiate a request for a response to a lower-priority emergency such as a panic emergency. It is anticipated that database 223 will contain information about various types of queries including information needed to display a panic query and also information about submitted panic queries and responses to panic queries. It is anticipated that this information will be periodically updated. In the most preferred embodiments of the present invention, and where desirable, the panic query may be stored in database(s) 223 of FIG. 2 and on first smartphone 190 used by a requestor. The panic query is displayed to the intended recipient using a user interface 224, which enables them to interact with the computer-based system that enables the computer-implemented method depicted in FIG. 4.

Next, the network computer system 100 will evaluate whether or not the requestor has initiated a request for a response to a panic emergency (step 415). In the most preferred embodiments, requestor initiate a panic request by selecting panic icon 602, as shown in FIG. 6A. If the request for a response to a panic emergency is not requested (step 415=“NO”), then the computer-implemented method is terminated. If it is requested (step 415=“YES”), such as a panic icon 602 being selected, the process continues. As shown by the dotted line in FIG. 4, in at least some preferred embodiments of the present invention, a panic alert is sent to the smartphone 191 of an administrator (step 417) and network computer system 100 instructs the smartphone app of smartphone 191 to display a confirm a panic query to an administrator 300 (step 419). Network computer system 100 then determines whether the administrator wants to acknowledge the panic emergency and put the school or classroom in a panic status (step 421). In the most preferred embodiments the system receives this acknowledgement through the smartphone app on the smartphone 191 of the administrator.

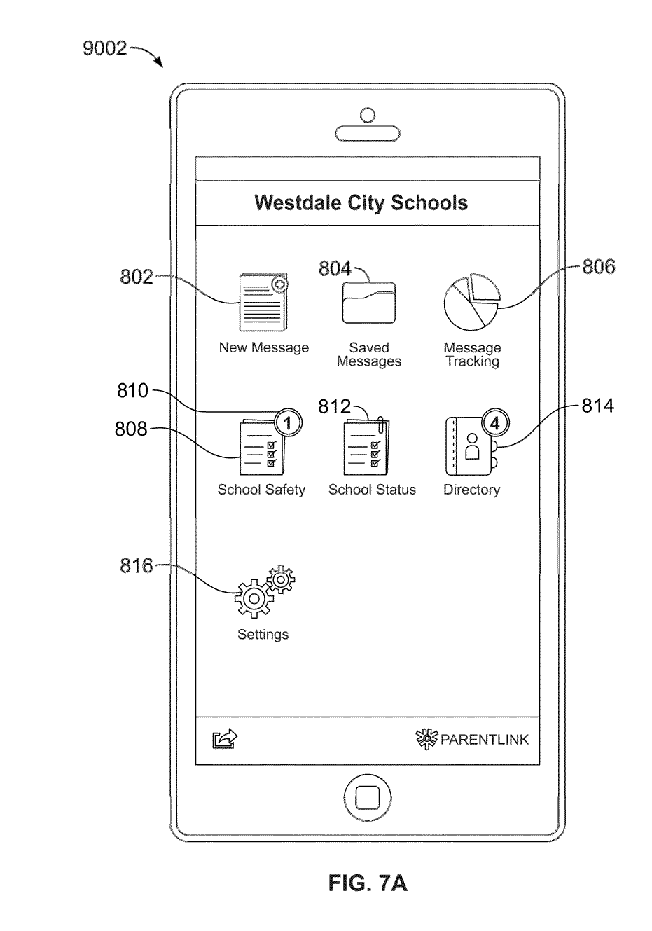

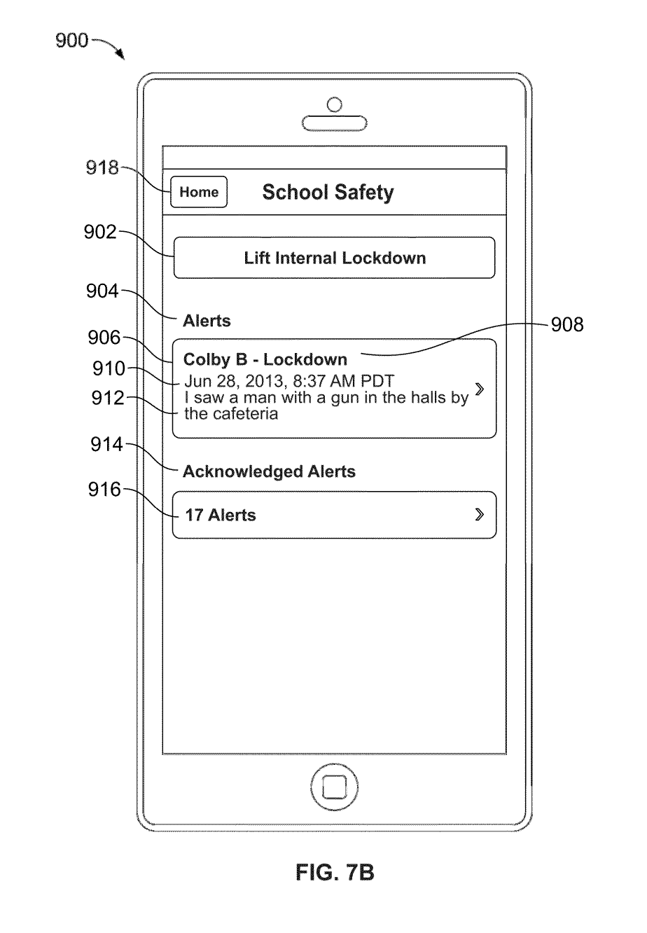

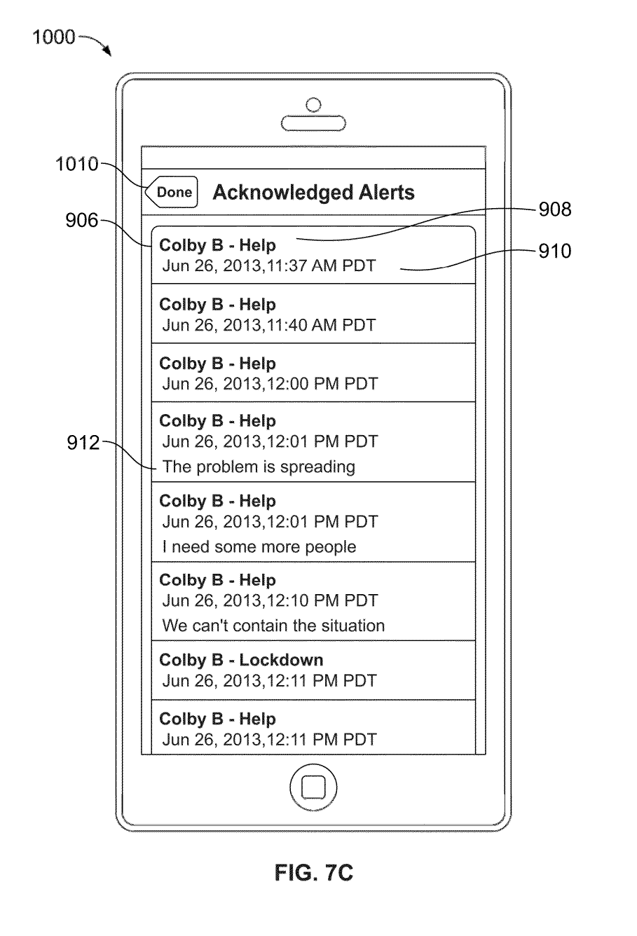

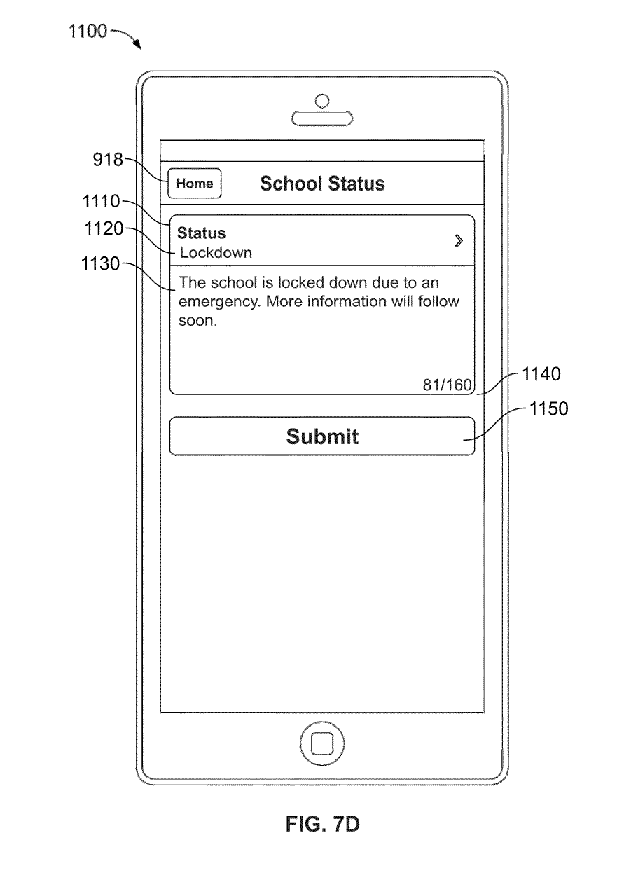

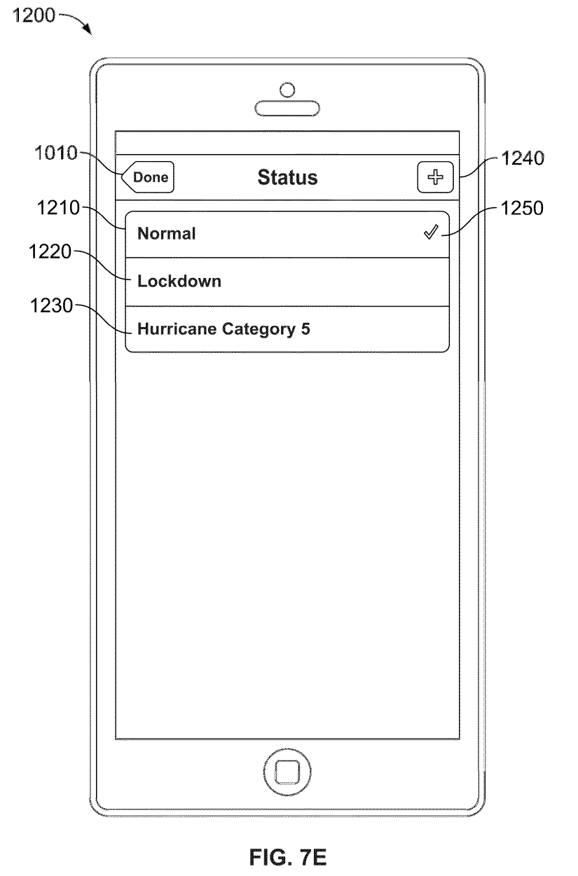

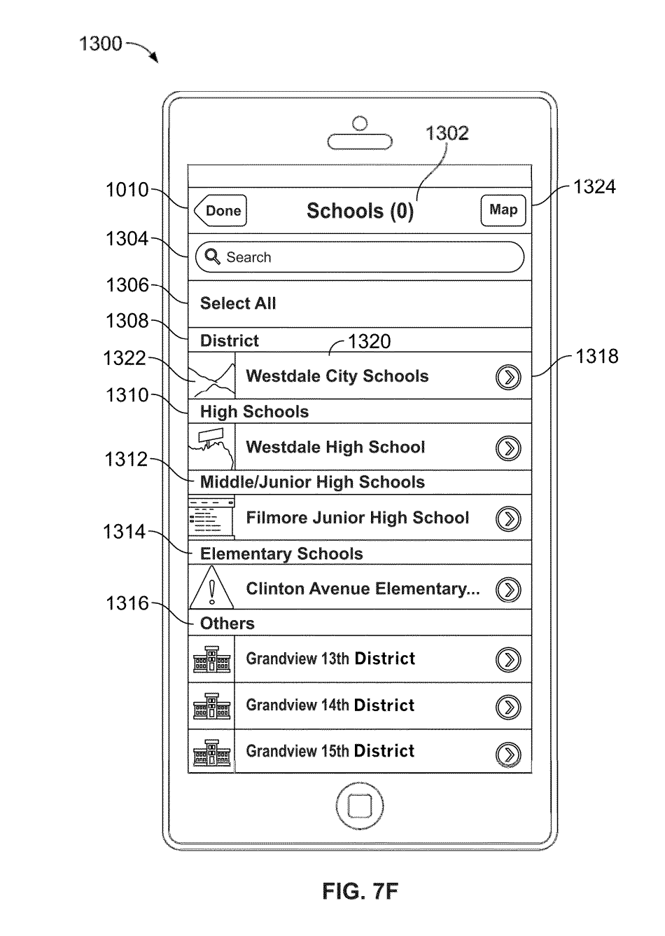

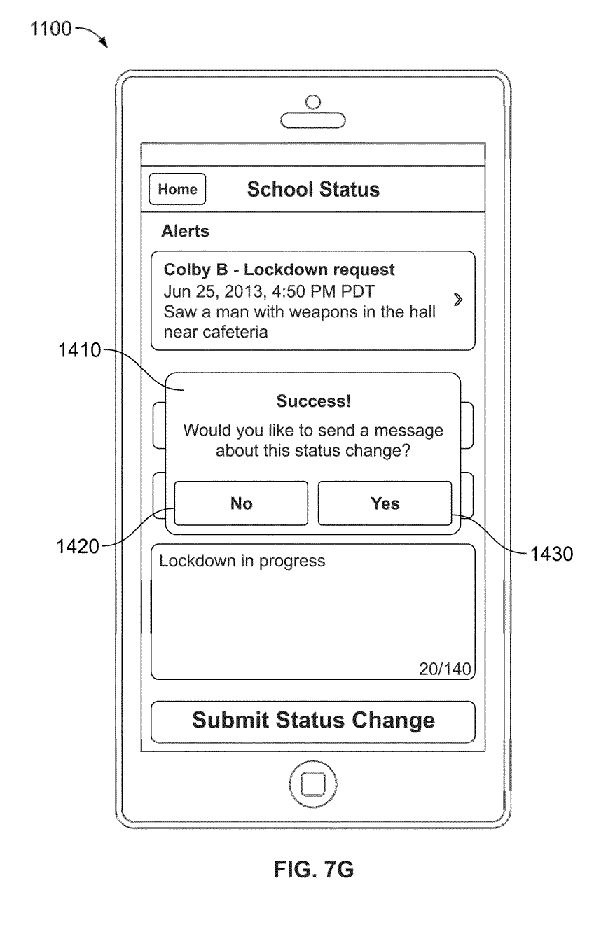

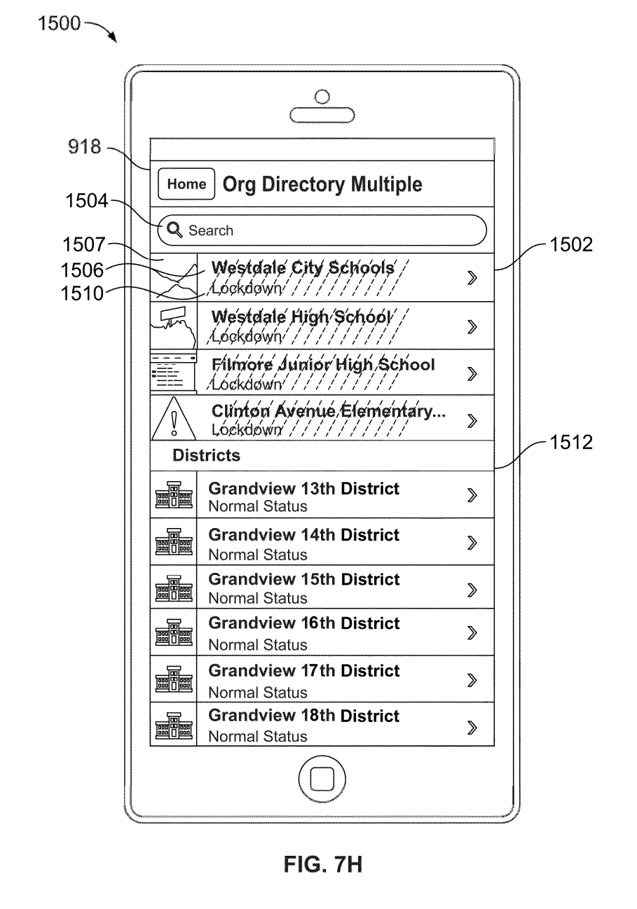

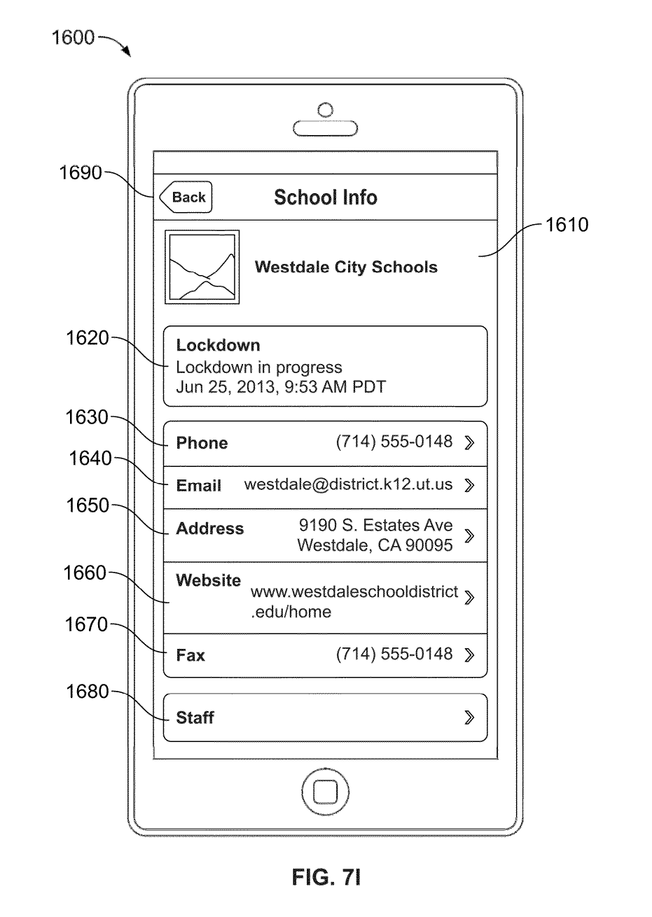

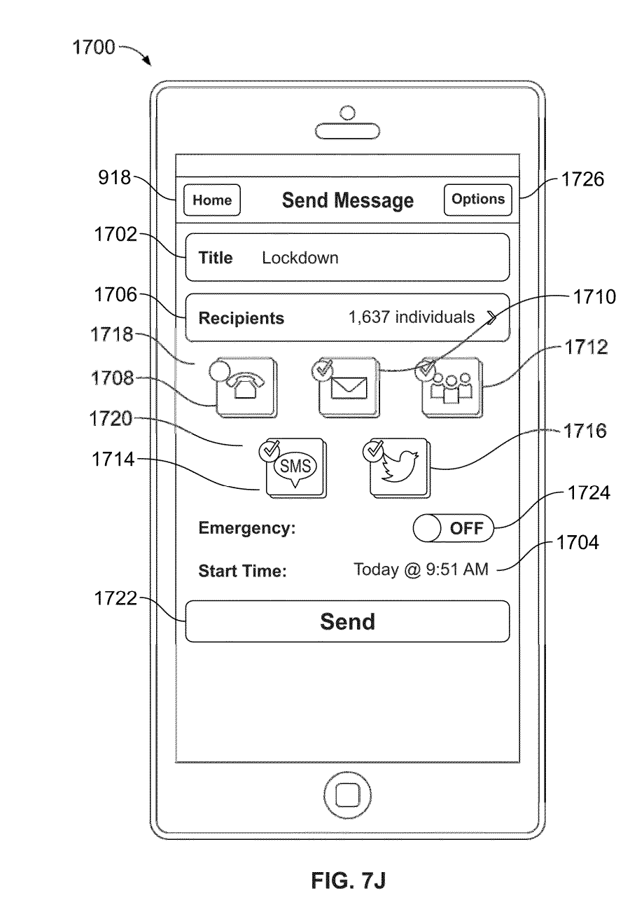

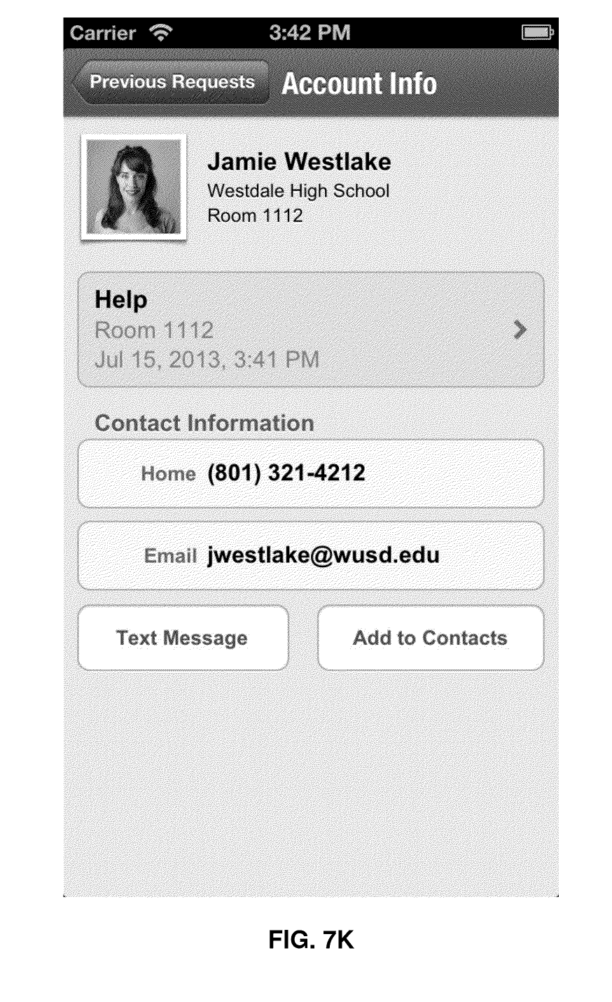

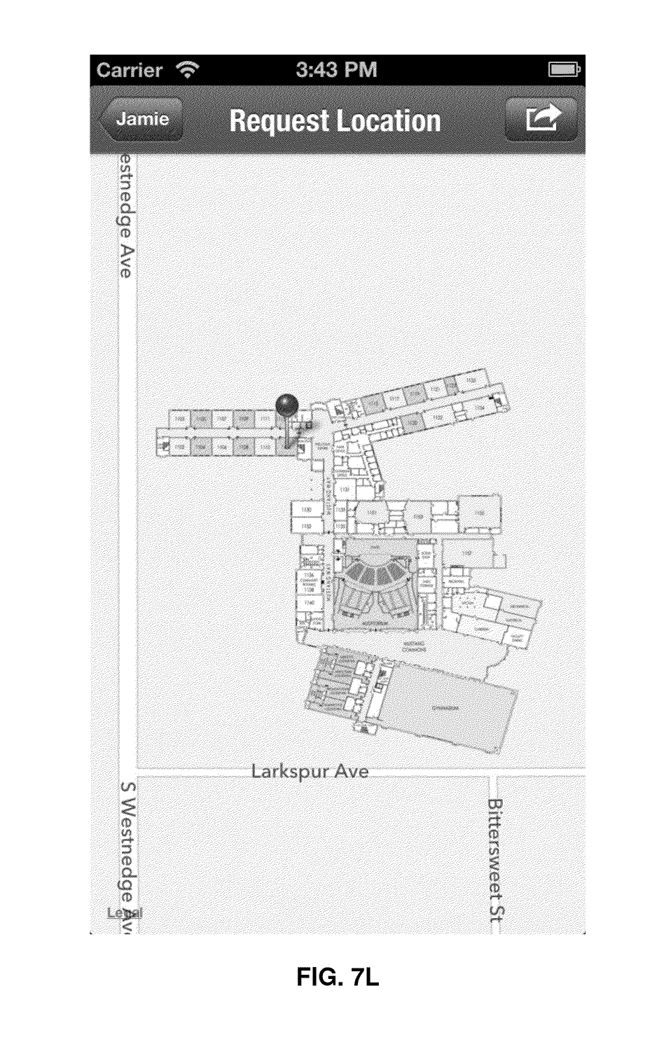

If the emergency panic is not acknowledged (step 421=“NO”), then the system will simply use the user interface 224 of the teacher user's device 192 to display a message informing them of the request denial (step 423). The teacher user will be redirected to step 410 of FIG. 4. The teacher user will again be prompted with a panic query as described in step 410, and can choose whether they want to request a panic as described in step 415. Some preferred embodiments allow for more information to be given through an optional message 702 as described later in regards to FIG. 7, In embodiments implemented using a user interface similar to the one described in FIG. 7 the teacher user would be able to make a new request for a panic and elaborate further on the situation if they believe that an emergency panic was incorrectly denied.

Alternatively, if the emergency panic is acknowledged (step 421=“YES”) then a number of steps automatically follow in order to respond to the panic. First, the status of the classroom will change to “panic” (step 425). This is an official status within the organization using this preferred embodiment of the method. Changing the status, also known as emergency status, may affect many things including which emergency communication call-trees are implemented and which groups of individuals are notified, changing who can access certain areas including the location of the teacher user that requested the panic status, and other safety precautions that the organization designates. Some organizations have a system that keeps track of the current status of the organization and any suborganizations and updating the status in the system is a part of this step for these organizations. In this embodiment of the method, the status is specific to a particular classroom, an example of a suborganization of the school, the organization utilizing the method. Other embodiments may only have a single status for the organization, or may update the status of many proximate or related suborganizations, such as an entire wing of classrooms around the teacher user's location.

Once the status of the classroom is changed to panic, the next step is to send a panic alert to the school security (step 427). It should be noted that the delivery method of the alert may be selected by the system and/or the user. The alert contains the information necessary for the school security to alleviate the problem causing the panic situation. This might include a location, description of the problem, time of the request, and the name of the requestor. Some embodiments would allow the school security to confirm to the administrator that they received the alert notification, and possibly a description of their plan of action.

Next, the system can be configured to automatically send notifications to all other appropriate personnel (step 429). In the described preferred embodiment this could include all of the staff working at the school. A push notification to a school smartphone app would notify them of the panic, and through the app, they could view the details of the panic situation in a manner illustrated in FIG. 7I with a status section 1620 on the school status page 1600. While this embodiment of the method notifies the school security before notifying the other appropriate personnel, other embodiments of the claimed method may notify people in a different order, or simultaneously.

After all the necessary notifications are sent to the intended recipients, the device upon which the user teacher sent the original request begins to record audio and video (step 431). In some embodiments, the system is configured to send a notification to the device of the requestor when the administrator receives the request by a notification such as a popup as shown in FIG. 6C; when the mobile device begins transmitting information such as audio feeds as shown in FIGS. 6C and 6D; when admin selects a button to notify requestor that help is on the way as shown in FIG. 6D; or when the administrator select the “initiate lockdown”. In admin app or in school safety drill down on help request and it shows the requestor, and other info like picture/contact info/role at the school and their outstanding help request as shown in FIG. 7K. The administrator application can also drill down to show the location where the requestor was when the requested for help was sent as shown in FIG. 7L. These recordings are broadcast to at least one secure device that can store them for analysis and evidence. This can include a device used by the administrator to help them determine if any more actions need to be taken or if the panic situation is finished.

The smartphone 191 of an administrator may then display a query asking whether the panic situation has ended (step 433). The display of this query may be performed similarly to the display of the query as described in step 419. The administrator may then determine the status of the panic situation and input it into the system similar to the method described in step 421 allowing the system to determine whether the panic situation is ended (step 435). If the situation has ended (step 435=“YES”) then the process of the method is ended. If the situation has not ended (step 435=“NO”), then the process returns to step 431 and continues to broadcast the recordings of the teacher user's device until it can determine that the panic situation has ended from the administrator's selection.

Referring now to FIG. 5, an overall process and method 500 for receiving and responding to a request for aid during a high-priority emergency, such as a lockdown, in accordance with a preferred embodiment of the present invention is shown. In the most preferred embodiments of the present invention, method 500 is a computer-implemented method used in conjunction with the hardware and software described in conjunction with FIG. 1, FIG. 2, and FIG. 8.

As shown in FIG. 5, the first step is generally to display a lockdown query to a potential requestor, such as a teacher user (step 510). As used herein, a lockdown query refers to a query asking whether a requestor wishes to initiate a request for a response to a high-priority emergency such as a lockdown response to an armed gunman. It is anticipated that database 223 will contain information about various types of queries including information needed to display a lockdown query and also information about submitted lockdown queries and responses to lockdown queries. It is anticipated that this information will be periodically updated. In the most preferred embodiments of the present invention, and where desirable, the lockdown query may be stored in database(s) 223 of FIG. 2 and on smartphone 190 used by a requestor. The lockdown query is displayed to the requestor using a user interface 9000, which enables them to interact with the computer-based system that enables the computer-implemented method depicted in FIG. 5.

Next, the network computer system 100 will evaluate whether or not the requestor has initiated a request for a response to a lockdown emergency (step 515). In the most preferred embodiments, a requestor initiates a lockdown request by selecting icon 600, as shown in FIG. 6A. If the request for a response to a lockdown emergency is not requested (step 515=“NO”), then the method ends its process. If it is requested (step 515=“YES”), such as icon 600 of FIG. 6A being selected, the process continues.

In this embodiment the school's status is changed to lockdown (step 525); that means that the current status of the school is stored in database 223; in some embodiments the school status is automatically updated to a publicly available site such as a school's website, a privately available site such as a school's intranet, or a smartphone app such as a community news feed app, an administrator app, or a teacher app. In other embodiments the school's status is automatically updated and alerts are sent out to all individuals including parents of students attending the school. In some embodiments which are configured to interact with a hierarchal organization, instead of changing a room status, such as a classroom, to high priority emergency status such as lockdown status 525, the entire organization's emergency status, such as a district's emergency status, is automatically updated and alerts may be sent automatically to district employees or the entire district.

As shown by the dotted line in FIG. 5, in at least some preferred embodiments of the present invention, a lockdown alert is sent to the smartphone 191 of an administrator (step 517) and network computer system 100 instructs the smartphone app of smartphone 191 to display a confirm lockdown query to an administrator (step 502). Network computer system 100 then determines whether the administrator has confirmed the lockdown emergency (step 521), and, if the administrator has confirmed (step 521=YES), the computer-based system 100 puts the school in a lockdown status 525. In the most preferred embodiments the system receives this acknowledgement through the smartphone app on the smartphone 191 of the administrator.

If the emergency lockdown is not acknowledged (step 521=“NO”), then the system will use the user interface 224 of the teacher user's device to display a message informing them of the request denial (step 523). The teacher user will be returned to the beginning of the method. They will again be prompted with a lockdown query as described in step 510, and can choose whether they want to request a lockdown as described in step 515. Some preferred embodiments allow for more information to be given through an optional message 702 as described in FIG. 6B. An optional message may be input by a requestor into a text box such as optional description text box 704 of FIG. 6B to elaborate the need for aid, which includes justifying the need for aid when an administrator has denied a request. In embodiments implemented using a user interface similar to the one described in FIG. 7, the teacher user may be able to use network computer system 100 to make a new request for a response to a panic emergency or elaborate further on the situation if they believe that an emergency lockdown was incorrectly denied; in some embodiments a user may submit an optional message using a text box such as optional description text box 704 of FIG. 6B.

Alternatively, if the emergency lockdown is acknowledged (step 521=“YES”) then a number of steps, in some embodiments, automatically follow in order to respond to the lockdown. First, the status of the classroom will change to “lockdown” (step 525). A status as used herein is an official status of an organization or sub-organization. Examples of statuses are “lockdown” which may mean a dangerous situation in which teachers must lock the doors of the classroom and follow predetermined procedures or an “earthquake” which means that an earthquake has occurred and that the organization should perform an earthquake response such as ducking under tables. Changing a status could affect many things including automatic implementation of an emergency communication protocol, automatically preventing individuals without permission to have access to certain areas including the location of the teacher user that requested the lockdown status, and other safety precautions that the organization has designated using a user interface of network computer system 100 (user interface not shown in the figures). In some embodiments network computer system 100 tracks the current status of the organization and the current status of any sub-organizations; In this embodiment of the method, the status is specific to a particular classroom, an example of a sub-organization of the school, the organization utilizing the method. Other embodiments may only have a single status for the organization, or may update the status of many proximate or related suborganizations, such as an entire wing of classrooms around the teacher user's location.

Once the status of the classroom has been changed to lockdown status (or a high tier emergency), the next step is to send a lockdown alert to the school security (step 527). It should be noted that the delivery method of the alert may be selected by the system and/or the user. The alert contains the information necessary for the school security to alleviate the problem causing the lockdown situation. This might include a location, description of the problem, time of the request, and the name of the requestor. Some embodiments would allow the school security to confirm to the administrator that they received the alert notification, and possibly a description of their plan of action.

Next, the system can be configured to automatically send notification to all other appropriate personnel (step 529). In the described preferred embodiment this could include all of the staff working at the school. A push notification to a school smartphone app would notify them of the lockdown, and through the app, they could view the details of the lockdown situation in a manner illustrated in FIG. 7I with a status section 1620 on the school status page 1600. While this embodiment of the method notifies the school security before notifying the other appropriate personnel, other embodiments of the claimed method notify people in a different order, or simultaneously.

After all the necessary notifications are sent to the intended recipients, the device upon which the user teacher sent the original request begins to record audio and video (step 531). These recordings are broadcast to at least one secure device that can store them for analysis and evidence. This can include a device used by the administrator to help them determine if any more actions need to be taken or if the lockdown situation is finished.

Smartphone 191 of administrator would then display a query whether the lockdown situation has ended (step 533). This would be performed similarly to the display of the query as described in step 519. The administrator would then determine the status of the lockdown situation and input it to the system similar to the method described in step 521 allowing the system to determine whether the lockdown situation is ended (step 535). If the situation has ended (step 535=“YES”) then the process of the method is ended. If the situation has not ended (step 535=“NO”), then the process returns to step 531 and continues to broadcast the recordings of the user teachers device until it can determine that the lockdown situation has ended from the administrator's selection.

Referring now to FIG. 6A-6B, a schematic representation of a user interface for sending requests for aid in an emergency is depicted in accordance with a preferred exemplary embodiment of the present invention. As shown in FIG. 6A, a graphical user interface 600 is provided via smartphone 190 for sending requests for aid in an emergency via a smartphone “app.” User interface 600 provides a plurality of icons that are used to represent different features within the user interface. In this case, each icon provides access to one or more features. In this example, user interface 600 is adapted for a typical educational environment for use by a teacher in a classroom setting. Those skilled in the art will recognize that user interface 600 is most preferably adapted for a touch screen device but may take other forms as well.

Icon 602 depicts a visual representation of the requestor. Icon 604 provides the consumer with access to a “stream” or aggregated feed of events which includes emergency events. The number “1” enclosed by a circle is a typical badge which represents the number of new updates which have been added to the “stream.” Typically, a “badge” or small icon may be temporarily superimposed over icon 902 to let the user know that a new notification has been issued. Icon 606 provides access to a feature in which a requestor can post an update message that will be distributed to others via communication server 225. Icon 608 provides access to a screen of user interface 9000 for requesting a response to a high priority emergency, such as a lockdown response. Icon 610 provides access to a screen of user interface 9000 for requesting a response to a low priority emergency, such as a panic emergency. In some embodiments when a requestor selects icon 608 or icon 610, the smartphone app software automatically instructs the smartphone 190 to automatically record audio information, video information, GPS information, or audio/visual information. In some embodiments when a requestor selects icon 608 or icon 610, the smartphone app software automatically instructs the smartphone 190 to automatically transmit audio information, video information, GPS information, or audio/visual information to network computer system 100. In some embodiments when a requestor selects icon 608 or icon 610, the smartphone app software displays a user interface 9012 with additional icons which when selected by a requestor then instruct the smartphone 190 to automatically record information such as audio information, video information, GPS information, or audio/visual information. In some embodiments when a requestor selects icon 608 or icon 610, the smartphone app software displays a user interface 9012 with additional icons which when selected by a requestor then instruct the smartphone app software to automatically instruct the smartphone 190 to automatically transmit audio information, video information, GPS information, or audio/visual information to network computer system 100. Icon 612 provides access to a feature in which a requestor can send a direct message to another administrator or teacher that will be distributed via communication server 225. Icon 614 provides access to a feature for displaying a directory of individuals in the organization, or for a hierarchal organization for individuals in the organization above, the organization itself and in sub-organizations. Icon 616 provides access to a “settings” or customization tool where the user can configure what type of information is recorded when icon 608 or icon 610 is selected, which administrators will receive a notification when icon 608 or icon 610 is selected, and the type of icons which are displayed on the user interface, such as the screen displayed in FIG. 6A.

When a requestor has selected icon 608, the user interface 600 then displays a screen as depicted in FIG. 6B. In this embodiment, network computer system 100 displays a confirm lockdown query to the requestor (and may be an optional part of “Display lockdown query to teacher user” (step 510) as depicted in FIG. 5). After a requestor has selected icon 608 or icon 610, user interface of smartphone 190 then displays a confirmation screen with a confirmation box 700 as disclosed in FIG. 6B. Confirmation box 700 may contain a header 702 such as “Confirm Lockdown Request?”, a message input area 704 which may be configured to receive text inputted by a keyboard, audio information recorded through a speaker, or visual information recorded by a camera attached to smartphone 190. Confirmation box 700 may also contain icon 706 which when selected instructs smartphone 190 to abort the request and icon 9012 which when selected instructs smartphone 190 to process the lockdown request by performing a step such as step 517 of FIG. 5 or sending a push notification to an administrator. In some embodiments a screen of confirmation box 700 contains open-ended fields with descriptors for collecting information or a survey with prompts for collecting information about the emergency.

FIG. 7A-FIG. 7J are a schematic representation of a user interface 9002 for receiving and responding to a request for aid during an emergency created by a computer-based system in accordance with a preferred exemplary embodiment of the present invention. In the most preferred embodiments, user interface 9002 are displayed on smartphone 192 by a smartphone app. Icon 802 provides access to a tool for composing a message and sending a message to others, including groups of intended recipients, other administrators, requestors, public relations personnel, third party responders, and the public. Icon 804 provides access to a tool for accessing saved messages which may be drafts of messages which have not yet been sent or are messages which were previously sent. Icon 806 provides access to a message tracking tool which is configured to display the status of messages which have been sent. Icon 808 provides access to a tool for viewing requests which have been sent to administrators. The tool associated with icon 808 may allow users to view the requests which have been sent to the device. In some embodiments it allows users to do one or more of the following: view the requests sent to all of the administrators in a certain organization or sub-organization, sort the requests which have been sent to administrators, acknowledge requests, or remove a status such as “lifting” a lockdown status (see icon 900 of FIG. 7B for one embodiment). To acknowledge a request, as used herein, means to take action on a request such as triaging a request, approving the request, or denying the request. Badge 810 may contain an update able element, such as a number, which signals to the administrator the number of requests which have not yet been acknowledged by the administrator, as shown in FIG. 7B. Icon 816 provides access to a “settings” tool or customization tool which may be configured so that an administrator can configure the user interface 600 or the smartphone app executed on smartphone 191. Icon 812 provides access to a tool, in which one embodiment is shown in FIG. 7D, for configuring or viewing the status of schools within an organization or the status of an organization. Although the depictions of preferred embodiments shown in FIG. 7A-7J. are directed towards an educational environment of a school, any other organization is contemplated by the various embodiments. Icon 814 provides access to a directory tool for viewing contact information of individuals or entities in an organization such as the same school as the administrator.

Referring to FIG. 7B, the school safety page 900 is depicted with an unacknowledged alert. The lift internal lockdown icon 902 provides a tool for removing a status, such as lifting an internal lockdown in the instance depicted. One skilled in the art would see that this page could include a similar button for each status of any type that needs to be lifted. The depicted application is designed for use by an administrator with authority for a single school or organization, but other embodiments of the application allow for the status to be lifted or changed for only some statuses or some suborganizations within an organization. When an administrator has selected icon 902, a notification may be sent to network computer system 100 and the notification may be storied in network computer system 100. In some embodiments, the status change will automatically initiate some action such as the status displayed on an internal intranet or on smartphone apps for employees of an organization may be changed to a non-emergency status, or network computer system 100 may send notifications to members of an organization such as staff of a school. In some embodiment a separate icon is displayed for “lifting external lockdowns”, that is removing the emergency status from publicly accessible status indicators, such as the school's website or public mobile application. Other ongoing actions that were initiated by the network computer system 100 at the beginning of the emergency are stopped upon selection of icon 902.

Below the lift internal lockdown button 902 is the new alerts section 904 that includes a list of all unacknowledged alerts. Each unacknowledged alert is listed with at least three elements: the name of the teacher user that made the request 906, the type of emergency 908, and the time and date of the request 910. If the teacher user also included an optional description using the optional description text box 704, then the alert description 912 is included below the time and date of the request 910. After the list of unacknowledged alerts is the acknowledged alerts section 914 that includes the acknowledged alerts button 916. The acknowledged alerts button 916 displays the number of previously acknowledged alerts and by selecting the button, the user interface displays the acknowledged alerts page 1000 depicted in FIG. 7C. At the top of the page is the home button 918 that, when selected, will return the administrator user to the administrator application's home page 9002.

Referring to FIG. 7C, the acknowledged alert page 1000 is depicted with the list of past alerts. In order to return to the school safety page 900, the administrator user can select the done button 1010 at the top left of the page. In the depicted embodiment, each alert on the list includes at least three elements: the name of the teacher user 906 that requested the emergency response, the type of emergency 908, and the time and date of the request 910. Most preferred embodiments include at least two types of emergency requests 908, such as help and panic. The most preferred embodiments are configured to respond differently according to the type of emergency request. If the teacher user included an optional description using the optional description text box 702, then the alert description 912 is included below the time and date of the request 910.

Referring to FIG. 7D, the school status page 1100 is shown with a status change to lockdown ready to submit. Similar to on the school safety page 900, the home button 920 at the top of the page will return the user interface to the administrator application's home page 9002. The status section 1110 shows the new status 1120 to which the organization status will be changed. Selecting the status section 1110 will take the user interface to the status selection page 1200 depicted in FIG. 7E allowing the administrator user to indicate what the new status should be. Below the status section 1110 is the status message section 1130. The status message allows the administrator user to write a short message describing the new status or the emergency details. Because the message text box shown in FIG. 7D has a limit on the size of the message; the depicted embodiment includes a character count 1140 at the bottom right of the status message. Selecting the submit button 1150, the administrator user will change the status of the organization and in the described embodiment will receive a confirmation notification 1410 as depicted in FIG. 7G. The status change will be sent to network computer system 100 to update the lockdown response. In the most preferred embodiments, if certain actions were already performed due to the previous status, the network computer system 100 would be configured to not perform them again in order to avoid redundancy.

Referring to FIG. 7E, the status selection page 1200 is shown with a normal status selected. At the top left of the page is the done button 1010 that will return the administrator user to the previous page, i.e. the school status page 1100 in this instance. The lower portion of the page contains a list of the possible statuses to be selected. In the preferred embodiment depicted this includes the normal status 1210, the lockdown status 1220 and the hurricane category 5 status 1230. If the desired status is not in the list, the user can press the add button 1240 to add the status to the list. In adding a new status to the list, some embodiments will allow the administrator user to select certain automated actions to be performed by network computer system 100 upon change to that status. This list of predetermined actions to be performed would be received by network computer system 100 and stored in the database 223 of network computer system 100. The user can select the new status for the status change in the list, and the currently selected new status is indicated by the check mark 1250 by the status. Other preferred embodiments can use other methods to indicate the currently selected new status such as coloring the status name or background.

Referring to FIG. 7F, the suborganization selection page 1300 is depicted for the selection of which schools are affected by the status page. This page is available to administrator users that have authority to change the status of multiple organizations, or when the status can be specified for particular suborganizations within the organization. To leave the page and return to the school status page 1100, the administrator user would select the done button 1010 similar to the status selection page 1200. At the top of the page is displayed the number of schools selected 1302. Also near the top of the page is a search bar 1304 enabling the administrator user to find a particular school, organization or suborganization. Below this is a select all button 1306 that allows the administrator user to select every school, organization or suborganization at once.

Below the select all button 1306 is the full list of organizations or suborganizations that are using the emergency response system presently disclosed. The list is organized by headers that separate all the sections. In the most preferred embodiments created for schools and school districts, this includes a districts header 1308, a high schools header 1310, a middle/junior schools header 1312, an elementary schools header 1314, and an others header 1316. Each school or organization section 1318 in the list includes the school or organization's name 1320 and icon 1322. If the school or organization section 1318 is clicked, the school or organization is selected to be affected by the status change. The map button 1324 takes the user interface to a map that shows all the selected schools or organizations.

Referring to FIG. 7G, the school status page 1100 is depicted with the status change confirmation notification 1410 including a message query. This is displayed after the administrator user has selected to submit the status change and the system has successfully made the change. If the administrator user selects not to send a message regarding the message change, they are redirected to the school safety page 1100. If the administrator user selects the yes button 1430 indicating that they would like to send a message regarding the status change, they are taken to a message creation page 1700 as depicted in FIG. 7J where the administrator user creates a message and designates the recipients.

Referring to FIG. 7H, the organization directory page 1500 is shown with some of the schools having an emergency lockdown status. Similar to the school safety page 900 the home button 920 will return the user interface to displaying the administrator application's home page 9002. The organization directory page 1500 displays an organized list of all suborganization via suborganization section 1502 in the organization using the emergency communication system and related mobile application in accordance with the most preferred embodiment depicted. At the top of the page, the user is able to search using the search bar 1504 in order to find a particular school on the list. Below this is the list of schools or suborganizations via suborganization sections 1502. Each school is listed with the school's name 1506 and the school's icon 1507. The list includes headers such as the district section header 1512 used for organizing the list. Above these headers are all the schools or suborganizations with an emergency status. The emergency status is also indicated in the list by some means such as the stripes in FIG. 7H or by coloring the school's tab. The specific status of the school or suborganization is indicated by the status report 1510 situated below the school name. Some embodiments only include this if there is a status other than normal. By selecting a suborganization section 1502 the user interface is directed to the information page of the suborganization such as the school information page 1600 depicted in FIG. 7I.

Referring to FIG. 7I, showing a school information page 1600 with an emergency status. In embodiments for other types of organizations, this page could be for the organization as a whole, or for one of the suborganizations that make up the organization with each suborganization having its own page. At the top of the page is the name of the school with a picture of the school or some other icon to indicate the school in the school name section 1610. Just below the name and the picture is the status section 1620 where the user of the application could find the current status of the school or organization associated with the information page. The status section includes the current status, a message describing the current status, and the date and time of the status change.

Below this is the contact information for the school including sections for the phone, email, address, website and fax. The phone number section 1630 includes the school or organization's phone number and is configured to allow the user to select it to further use the number, such as dial, message or save to contacts. The school email section 1640 similarly allows the user to see the school or organization's email, and to select it to create and send an email or to save it to contacts. The address section 1650 allows the user to see the address and select it to use it in a map application. The website section 1660 allows the user to see the school's website and open the URL in a web browser. Lastly the fax section 1670 allows the user to see the school's fax number and save it to their contact information. At the bottom of the page is the staff button 1680 which, when selected, takes the user to a page displaying a directory of the staff working at the school or organization. The user can select the back button 1690 in order to return to the organization directory page they were viewing before the school information page.

Referring now to FIG. 7J, showing a message creation page 1700 for the purpose of responding to emergency requests received. As communication is an important part of properly dealing with an emergency situation, most preferred embodiments enable the user to create and send messages to the appropriate persons to inform them of the emergency and any desired details such as location or an action plan. The title of the message 1702 is automatically set to be the current emergency status in order to call the attention of the message recipients to the importance of the message. Some embodiments allow the user to edit this title as desired. The message will also include the current time as indicated in the start time section 1704 of the message creation page 1700. The user is also able to select individuals or groups of individuals to receive the message, the illustrated embodiment showing the total number of individuals selected to receive the message in the recipient section 1706 of the message creation page 1700.

Most preferred embodiments are configured to be able to distribute the message via a plurality of messaging mediums. The message creation page 1700 has a section of selectable icons that represent which mediums through which the message will be sent. In the illustrated embodiment this section includes a phone icon 1708, email icon 1710, Facebook™ 1712, SMS icon 1714, and a Twitter™ icon 1716. The upper left hand corner of the icon has a blank badge 1718 if it is unselected, or a check badge 1720 if it is selected. The message is sent by pressing the send message button 1722, and when the message is sent, it will be configured for each of the methods represented by the selected icons and distributed.

The message creation page 1700 also includes the option to designate the emergency status of the message using the emergency status toggle 1724 the emergency status allows the messages with an emergency status to bypass certain filters of a message management system. Network computer system 100 may include filters, and network computer system may allow filters to be configured to allow filters to be by-passed based on the priority status of emergency messages.

As shown in FIG. 7J, a user interface 1100 for adding content to messages for delivery by optimized message creation and delivery 100 of FIG. 1 in accordance with a preferred exemplary embodiment of the present invention is depicted. User interface 1100 represents a typical user interface that might be displayed by mobile communication device 910 of FIG. 1. As shown in FIG. 7J, user interface 1100 includes a plurality of icons 1010, with each icon 1010 representing a different communication or message delivery platform that can be specified for sending messages to one or more recipients. Badge 1020 is an icon that provides visual feedback to the message originator to identify which message delivery platform(s) have been selected. In this case, the message originator has identified email, Twitter® and SMS text messaging as the desired message delivery platforms and the message text content is displayed in text box 1130. In addition, the message originator has also included two attachments to the message, as indicated by attachment icons 1140. The message originator may add any type of attachments to the message that are supported by the operating system and application software associated with mobile communication device 190 of FIG. 1.

It should be noted that the message text 1130 may be automatically truncated or adjusted as necessary to comply with the text limits of the selected delivery platforms. For example, the email option will may allow virtually unlimited textual content to be included in the email. However, Twitter® has a 140 character limit for messages and some SMS text messaging platforms also have a character limitation (e.g., 160 characters). In these cases, the textual content may be programmatically truncated or otherwise manipulated to comply with the limitations inherent in the message delivery platform.

In addition, in at least some preferred embodiments of the present invention, a visual indicator may be displayed to the user as the textual content is entered, alerting the message originator that some of the textual content may not be delivered. This will allow the message originator to adjust the textual content as necessary. For example, in FIG. 11, the textual information that will be included in the character limited delivery platforms is shown as highlighted text, indicating to the message originator that the non-highlighted text will not be sent to those message recipients who have specified SMS or Twitter®. Additionally, certain message recipients may not have the capability to receive attachment on their mobile communication device and, accordingly, they will not receive the attachments. Alternatively, a color may be used to highlight one or more of message delivery platform icons 1010, if the length of the textual content is incompatible with one or more of the selected message delivery platforms.

Some embodiments of the present invention may also utilize automatic door locking devices as part of an emergency action. The network computer system 100 may send a notification to an automated door lock that is capable of receiving a notification to automatically lock, such as the devices described in U.S. patent application Ser. No. 12/280,405. In the preferred embodiment of the present invention, which may depend on the type of emergency that has been authorized by the administrator, network computer system 100 may send notifications to the appropriate automatic door lock devices school wide, or to only a specific classroom, according to the type of emergency authorized by the administrator or by predetermined plans, which may be default plans or administrator-configured plans using a user interface. For examples, network computer system 100 may be configured so that an administrator using a user interface can select from a list of doors which doors should close when a lockdown request has been acknowledged and the lockdown request has originated from a specific location. Alternatively, an administrator may select areas such as classrooms from a map displayed by network computer system 100 and network computer system may be configured to automatically lock doors within a specified distance from the selected area or are within the same general area as the selected area, such as in the same wing of a school. Alternatively, the administrator may use a user interface to configure network computer system 100 to close all doors within a specified distance from locations for which lockdown request were sent. Alternatively, administrators may use network computer system to select areas on a map, such as by using a mouse, and any doors within that area will automatically lock when a lockdown response has been initiated for classrooms within that area. Alternatively, the locks can be configured such that even when doors have been locked, individuals can still open the door to exit a building or a classroom but unauthorized individuals who do not have a key or passcode cannot unlock the lock to enter a building or a classroom. Authorized administrators may use network computer system to unlock doors after a lockdown request has been lifted.

As will be appreciated by one skilled in the art, aspects of the disclosed network computer system disclosed herein may be embodied as a system, method or computer program product. Accordingly, aspects of the network computer system may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the network computer system may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the network computer system may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

From the foregoing description, it should be appreciated that system and method for event tracking and messaging disclosed herein presents significant benefits that would be apparent to one skilled in the art. Furthermore, while multiple embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. A computer-based system for receiving, storing and distributing emergency status notifications for at least one organization comprising:
at least one processor;
at least one memory coupled to the at least one processor;
a database:
a request mechanism residing in the at least one memory, the request mechanism configured to receive at least one request for at least one administrator to initiate a response to an emergency, the request originating from a device belonging to at least one requestor; and
a response mechanism residing in the at least one memory, the response mechanism configured to perform at least one automated action in response to the at least one request.

2. The computer-based system of claim 1 wherein the response mechanism is further configured to send at least one notification of the at least one request to a device of the at least one administrator and to receive a confirmation to perform the at least one automated action before performing the at least one automated action.

3. The computer-based system of claim 1 wherein the request mechanism is further configured to receive an optional message with the at least one request and the response mechanism is configured to send the message with a notification of the at least one request to a device of the at least one administrator.

4. The computer-based system of claim 1 wherein the response mechanism is further configured to receive at least one contemporaneous feed selected from the group consisting of an audio feed and a video feed originating from the device of the at least one requestor.

5. The computer-based system of claim 1 wherein the request mechanism is further configured to receive from the device of the at least one requester at least item selected from a group consisting of
a GPS coordinate, and
a name of the at least one requestor.

6. The computer-based system of claim 1 wherein the response mechanism is further configured to receive the selection of at least one requestor-selected request tier
and the response mechanism is further configured to initiate a response to the at least one request.

7. The computer-based system of claim 6 wherein the response mechanism is further configured to store a first predetermined response associated with a request of a first type of category and a second predetermined response to a request associated with a second type of category wherein the second predetermined response is different than the first predetermined response.

8. The computer-based system of claim 7 wherein the response mechanism is further configured to initiate a first predetermined response associated with a request of a first category when the computer-based system receives a request for a response to the request of the first category, the response mechanism comprising at least one automated action.

9. The computer-based system of claim 1 wherein the at least one automated action includes sending at least one message to at least one communication specialist within the at least one organization.

10. The computer-based system of claim 1 wherein the response mechanism is further configured to instruct a user interface on the device of the at least one administrator to a) display the at least one request and b) indicate whether the at least one request has been acknowledged by an administrator.

11. The computer-based system of claim 1 wherein the response mechanism is further configured to interact with a user interface of the device of the at least one requestor, the administrator or at least one third party and the at least one organization comprises at least one sub-organization and the at least one automated action is associated with at least one of the at least one sub-organization and the user interface is configured to display a list of the at least one sub-organization and wherein the list indicates the at least one sub-organization associated with the at least one automated action.

12. The computer-based system of claim 11 wherein the user interface is configured to show the current emergency status of at least one organization, at least one sub-organization, or at least one organization and sub-organizations selected by the user of the user interface.

13. The computer-based system of claim 1 wherein the response mechanism is further configured to send at least one message to at least one user and wherein the at least one automated action comprises using the response mechanism to send at least one message regarding the emergency to at least one.

14. The computer-based system of claim 1 wherein the at least one automated action is a plurality of automated actions comprising sending a first message to a first group of message recipients and later sending a second message to a second group of message recipients.

15. The computer-based system of claim 13 wherein the at least one processor is connected to a web server and sending the at least one message comprises updating a website to indicate at least one emergency status of the at least one organization, the at least one sub-organization, or the at least one organization and the at least one sub-organization.

16. The computer-based system of claim 1 wherein the at least one automated action includes locking at least one door.

17. The computer-based system of claim 1 wherein the at least one automated action includes performing a lockdown of the at least one organization, the at least one sub-organization of the at least one organization, or the at least one organization and the at least one sub-organization of the at least one organization.

18. The computer-based system of claim 17 wherein the lockdown is configured to allow its termination by a request originating from a device of the at least one administrator.

19. A computer-implemented method for responding to an emergency comprising:
receiving from a device of at least one requestor a request to initiate a response to an emergency;
sending a notification of the request to a device of at least one administrator; and,
receiving a confirmation from the administrator to initiate a response to the request.

20. The computer-implemented method of claim 19 wherein receiving the request includes receiving a GPS coordinate from the device of the requestor.

21. The computer-implemented method of claim 19 further comprising receiving from the device of the at least one requestor a live broadcast of audio and video.

22. The computer-implemented method of claim 19 further comprising receiving from the device of a requestor a requestor-selected request tier selected from a group consisting of at least one request tier type; and,
implementing at least one automated action from a list comprising at least one automated action associated with the request tier type selected by the requestor.

23. The computer-implemented method of claim 19 further comprising sending a notification to the device of an authorized administrator for which permission for the administrator to update a website with the emergency status of at least one organization, at least one sub-organization, or at least one organization and at least one sub-organization has been stored in the memory of a network computer system;
receiving an instruction from the device of the authorized administrator to update the emergency status of the at least one organization, the at least one sub-organization, or the at least one organization and the at least one sub-organization, sending a notification to the device of an administrator; and,
updating a website with the emergency status.

24. The computer-implemented method of claim 19 further comprising displaying via the user interface of the device of the administrator an indication that the request has been acknowledged by an administrator.

25. The computer-implemented method of claim 19 further comprising associating a requestor with a sub-organization; and,
displaying in a directory via the user interface of the device of the requestor, the user interface of the device of the administrator, or the user interface of a device of a third-party, the name of the requestor and the name of at least one sub-organization associated with the requestor.

26. The computer-implemented method of claim 1 further comprising posting on a website a message about the emergency status of at least one organization, at least one sub-organization, or at least one organization and at least one sub-organization.

27. The computer-implemented method of claim 1 further comprising locking at least one door of an organization, a sub-organization, or an organization and a sub-organization.
